(19) United States
(12) Patent Application Publication
(10) Pub. No.: US 2015/0332303 A1
(43) Pub. Date: Nov. 19, 2015

(54) SYSTEM AND METHOD FOR CREATING AND UPDATING COMPLETE CUSTOMER PROFILE

(71) Applicant: Lakshmi Mallikarjun Kodali, Hyderabad (IN)

(72) Inventor: Lakshmi Mallikarjun Kodali, Hyderabad (IN)

(21) Appl. No.: 14/536,702

(22) Filed: Nov. 10, 2014

(30) Foreign Application Priority Data
May 19, 2014 (IN) 2493/CHE/2014

(51) Int. Cl. G06Q 30/02

(52) U.S. Cl. CPC G06Q 30/0224; G06Q 30/0226

(57) ABSTRACT

A method and system for creating and updating customer profile are disclosed. The method includes collecting a plurality of individualized details of customer; and activities of the customer, evaluating the plurality of individualized details of customer and activities of the customer; and creating and updating the customer profile in response to the plurality of individualized details of customer and activities of the customer for enabling the plurality of merchants to view the customer profile, whereby the plurality of merchants identify the customer as a preferred customer by viewing the customer profile and provide privileged services.

### COPYRIGHT & TRADEMARK NOTICES

A portion of the disclosure of this patent document may contain material, which is subject to copyright protection. The owner has no objection to the facsimile reproduction by any one of the patent document or the patent disclosure, as it appears in the Patent and Trademark Office patent file or records, but otherwise reserves all copyrights whatsoever.

Certain marks referenced herein may be common law or registered trademarks of the applicant, the assignee or third parties affiliated or unaffiliated with the applicant or the assignee. Use of these marks is for providing an enabling disclosure by way of example and shall not be construed to exclusively limit the scope of the disclosed subject matter to material associated with such marks.

### TECHNICAL FIELD

The present disclosure generally relates to data collection and analysis systems and methods. More particularly, the present disclosure relates to a system and method for creating and updating customer profile in response to customer activities.

### BACKGROUND

Typically, merchants prefer to attract most of the customers and prefer frequent visits of the customer to their business location or utilize the services offered. Merchants promote their business by providing varied types of on-line/off-line deals and discounts to promote the business and in turn attract the customers to increase the sales.

Also, most of the customers prefer to purchase or avail services from merchants based on the deals, offerings and also services provided by merchants. The frequency of the customer visiting a business location or the frequency of the customer performing on-line transaction over the merchant portal depends on the quality of service offerings and based on the previous or current offerings or deals or discounts offered by the merchant.

In the light of afore mentioned discussion, there is a need for a system and method for creating and updating customer profile in response to customer activities and provide services more efficiently.

### BRIEF SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

A more complete appreciation of the present disclosure and the scope thereof can be obtained from the accompanying drawings which are briefly summarized below and the following detailed description of the presently preferred embodiments.

An exemplary objective of the present disclosure is to create a customer profile and update the customer profile.

An exemplary objective of the present disclosure is to update a customer profile in response to activities performed by the customer.

Another exemplary objective of the present disclosure is to provide the customer profile to the merchants to identify the preferred customers and provide privileged services.

### BRIEF DESCRIPTION OF DRAWINGS

Other objects and advantages of the present invention will become apparent to those skilled in the art upon reading the following detailed description of the preferred embodiments, in conjunction with the accompanying drawings, wherein:

FIG. 1A illustrates an exemplary block diagram for establishing a communication between the customers and merchants through the networked platforms.

FIG. 1B is an exemplary diagram for collecting spending activities of the customer through the networked platforms.

FIG. 1C is a diagram depicting embodiments connected to the system for creating and updating customer profile in response to customer activities.

FIG. 1D is a diagram depicting the system for creating and updating customer profile in response to customer activities.

FIG. 1E is a block diagram depicting a customer profile.

FIG. 1F is a block diagram for customizing profile of the customer with respect to the specific category of a merchant.

FIG. 1G is a block diagram for generating loyalty points by the merchants in response to the customer's activities in campaigns.

FIG. 2A is a diagram illustrating an exemplary user interface displaying customer spending activities.

FIG. 2B is a diagram illustrating an exemplary user interface of deals provided to the customer.

FIG. 2C is a diagram illustrating an exemplary user interface of reviews provided by the customer.

FIG. 2D is a diagram illustrating an exemplary user interface of invitations to be sent by the customer.

FIG. 2E is a diagram illustrating an exemplary user interface describing loyalties provided by the merchants in response to the spending activities of the customers.

FIG. 2F is a diagram illustrating an exemplary user interface of wishlist of customers.

FIG. 2G is a diagram illustrating an exemplary user interface displaying profile of the customer.

FIG. 2H is a diagram depicting an exemplary user interface for gamifying (also referred as improving the profile score) of the customer.

FIG. 3A is a diagram illustrating an exemplary user interface provided by the system for merchants.

FIG. 3B is a diagram illustrating an exemplary merchant registration user interface.

FIG. 3C is a diagram illustrating an exemplary user interface for claiming the business by a registered merchant.

FIG. 3D is a diagram illustrating an exemplary user interface directed to claim the business name of the merchant.

FIG. 3E is a diagram illustrating an exemplary user interface for login of the registered merchant.

FIG. 3F is a diagram illustrating an exemplary user interface for creating a campaign by the merchant.

FIG. 3G is a diagram illustrating an exemplary user interface for selecting target customers.

FIG. 3H is a diagram illustrating an exemplary user interface of turning customers to loyalist customers.

FIG. 3I is a diagram illustrating an exemplary user interface for creating a deal to the preferred customer.

FIG. 3J is a diagram illustrating another exemplary user interface for creating a deal to the preferred customer.

FIG. 3K is a diagram illustrating another exemplary user interface for creating a deal to the preferred customer.

FIG. 3L is a diagram illustrating another exemplary user interface for creating a deal to the preferred customer.

FIG. 3M is a diagram illustrating an exemplary user interface displaying merchant dashboard.

FIG. 3N is a diagram depicting en exemplary user interface of a merchant for creating precise campaigns.

FIG. 3O is a diagram depicting a user interface of merchant viewing customer profile.

FIG. 4A is a diagram depicting an exemplary method of tracking and evaluating activities of customer.

FIG. 4B is a flow diagram illustrating an exemplary method of viewing spending activities by the customer.

FIG. 4C is a flow diagram 400c illustrating an exemplary method of displaying loyalty benefits provided by the merchants.

FIG. 4D is a flow diagram illustrating an exemplary method updating the customer profile for receiving loyalty benefits.

FIG. 4E is a flow diagram illustrating an exemplary method of filtering merchants by the customers.

FIG. 5A is a flow diagram illustrating an exemplary registration process of merchant.

FIG. 5B is a flow diagram illustrating an exemplary method of claiming merchant's business.

FIG. 5C is a flow diagram illustrating an exemplary method of creating a campaign by the merchant.

FIG. 5D is a flow diagram illustrating a method of creating a deal to the customers by the merchant.

FIG. 5E is a flow diagram illustrating a method of transmitting invitations to privileged customers by the merchants.

FIG. 5F is a flow diagram illustrating a method of filtering preferred customers by the merchants.

FIG. 6 is a flow diagram 600 illustrating an exemplary method of analyzing customer profiles for providing preferred customer list to the merchants

### DETAILED DESCRIPTION

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting.

The use of “including”, “comprising” or “having” and variations thereof herein is meant to encompass the items listed thereafter and equivalents thereof as well as additional items. The terms “a” and “an” herein do not denote a limitation of quantity, but rather denote the presence of at least one of the referenced item. Further, the use of terms “first”, “second”, and “third”, and the like, herein do not denote any order, quantity, or importance, but rather are used to distinguish one element from another.

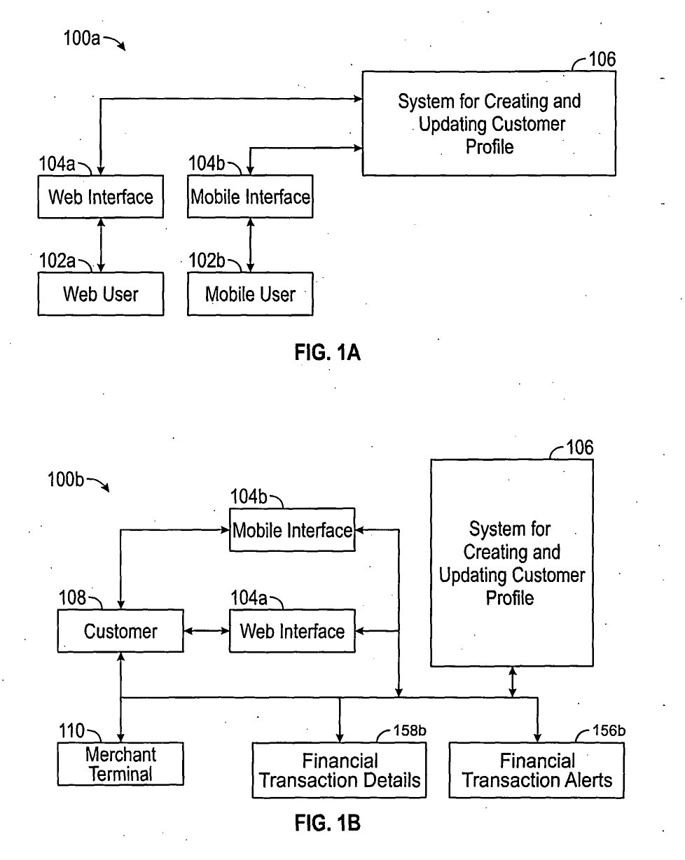

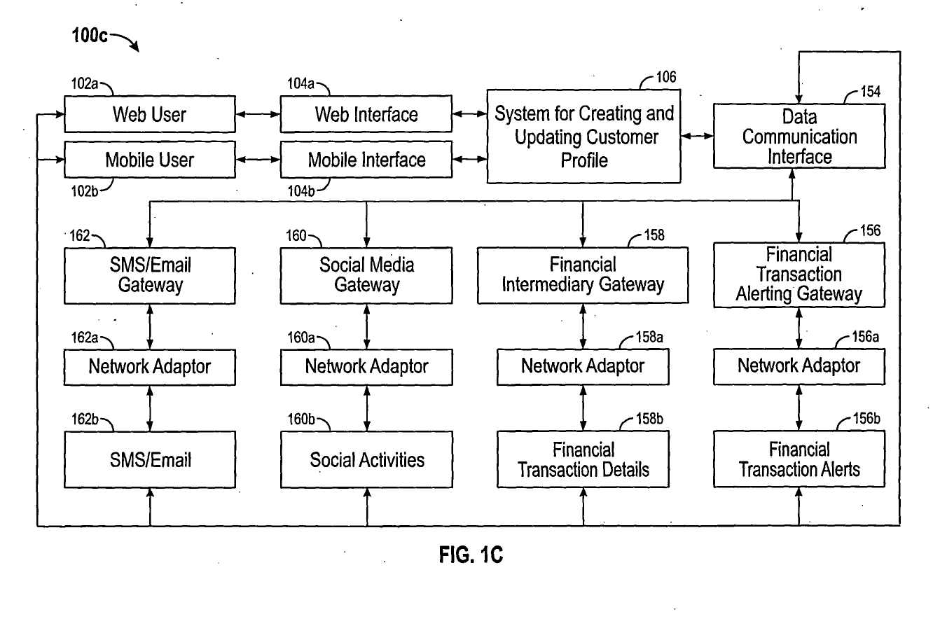

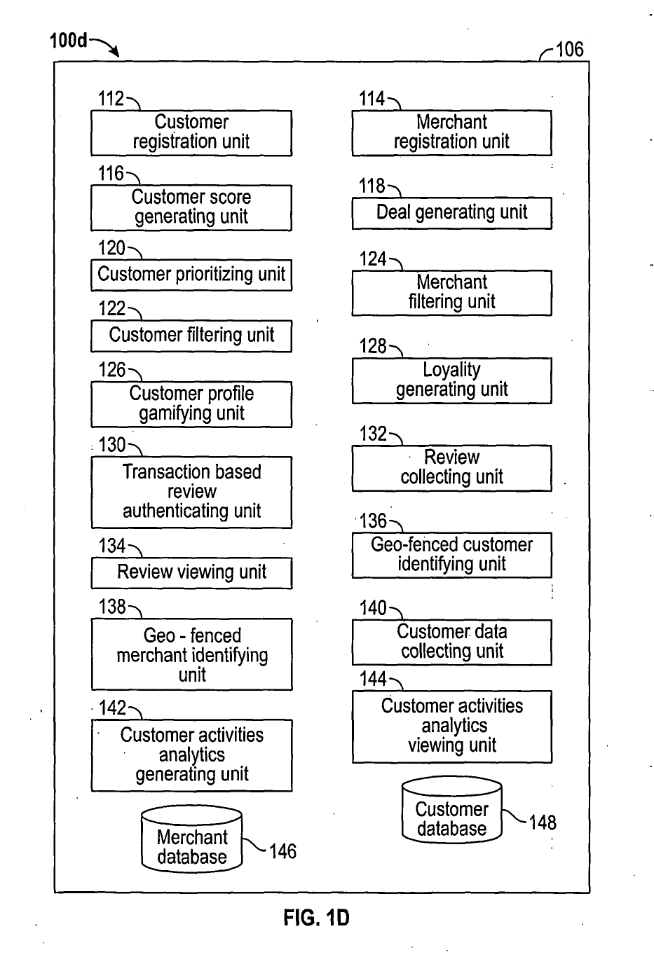

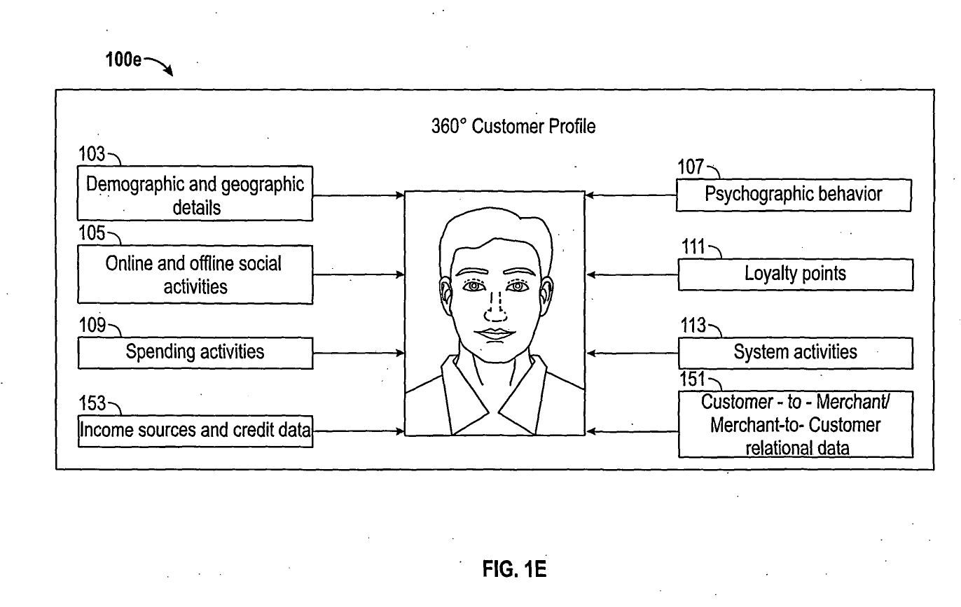

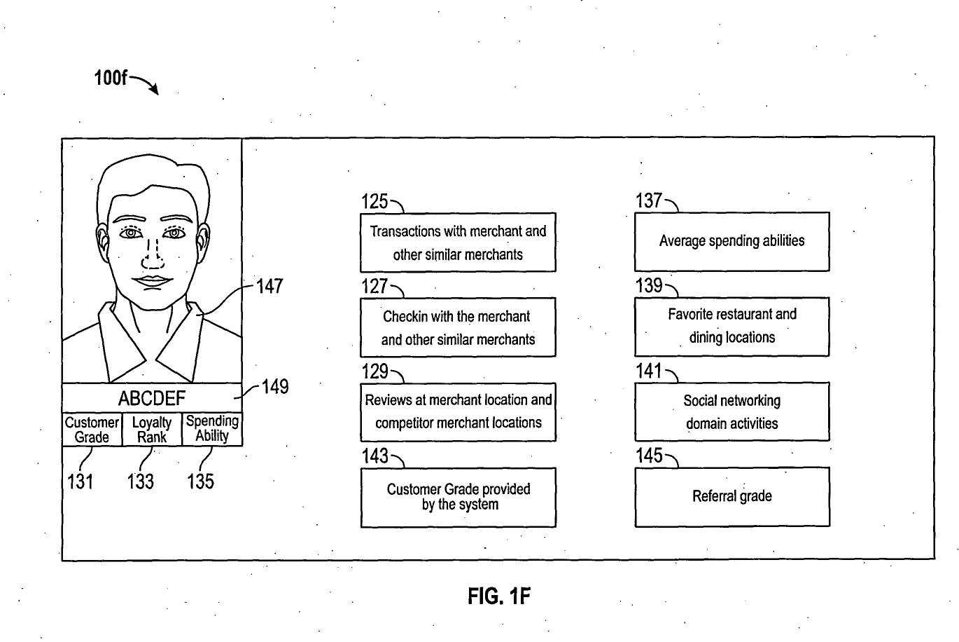

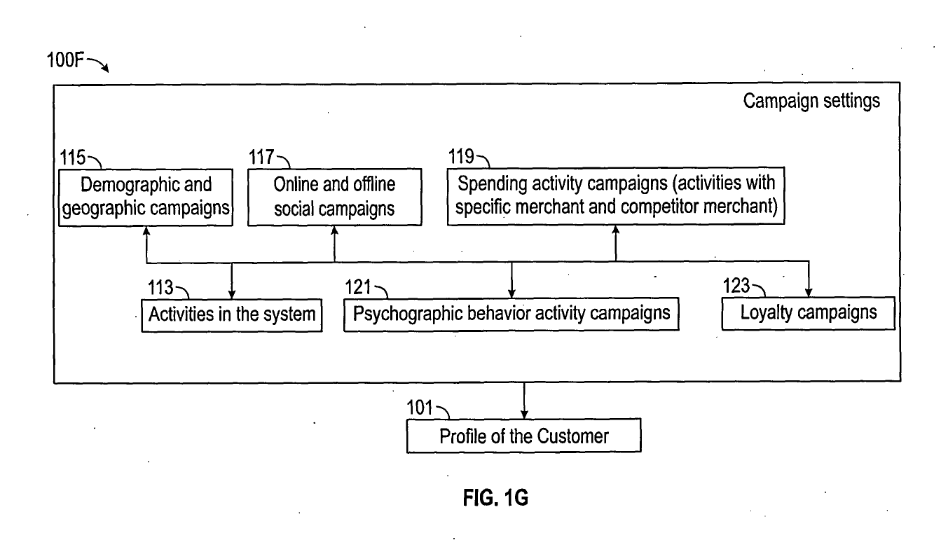

Referring to FIG. 1A, illustrates an exemplary block diagram for establishing a communication between the customers and merchants through the networked platforms. The system for creating and updating customer profile in response to customer activities 106 (herein after referred as system 106. The system 106 provides the profiles of the customers for enabling the merchants in identifying the preferred customers for providing privileged services. The privileged services here may include, but are not limited to, personalized services on visiting a merchant location, providing a dedicated service manager at merchant location, VIP services at merchant location, advance reservations facilities at customer location, individualized deals, individualized loyalty benefits, reward points and the like. The words individualized profile/customer profile/profile of the customer/individualized customer profile are used alternatively throughout the description.

For example, a merchant or a customer here may be referred as a web user 102a or a mobile user 102b communicates with the system 106. The system 106 may be accessed through networked platforms including, but not limited to, a web interface 104a and/or mobile interface 104b. The system 106 may comprise software components or hardware components or combination thereof. The system 106 may be configured to facilitate the merchants in providing privileged services to the preferred customers based on the activities of the customers.

The customer may be allowed to register with the system 106 to create a profile. The profile of the customer may be updated based on based on individualized details which may include demographic and geographic details of the customer (e.g., gender, age, occupation, education, industry, city, state, country, date and time and the like), online and offline social activities, psychographic behavior (e.g., reviews, spending pattern, whish list, likes and dislikes, spending at a competitor merchant store, purchase details, customer preferences), spending activities, income sources and credit data (e.g., overall income from different sources, disposable income, account balance, loans and debits, investments, FICO score/credit score, credit report and the like) loyalty (e.g. old customers loyalty points, current customers loyalty points, life time value of loyalty points, previous year purchases, lifetime purchases), activities in the system 106 and customer-to-merchant relational data and merchant-to-customer relational data (e.g., customer in person reviews to the merchant, customer feedback, and customer reviews, specific notes provided by the customer to the merchant, merchant specific notes about the customer, favorite preferences of the customer, notifications for customer requests, specific event related dates of the customer (birthday, anniversary etc), sales agent interaction details with the customer) and the like, without limiting the scope of the disclosure. The customer may also be allowed to provide details of payment cards associated with one or more financial intermediaries, account number associated with the financial intermediary, personal interests and/or preference, social networking account details and the like without limiting the scope of the disclosure to create the customer profile. The payment cards here may refer to debit card and/or credit card or other similar cards used for paying a merchant for the purchases made with the merchant. The social networking accounts here may refer to accounts in social networking domains, for example, Facebook, Twitter, Google Plus and the like.

The merchants may be allowed to register with the system 106 and create merchant profile. Furthermore, the merchants may be allowed to view the profiles of the registered customers and identify the preferred customers based on the customer profile, activities of the customer and provide privileged services. The activities of the customer here may include but not limited to activities in the system 106, spending activities, social networking activities in the social networking accounts and the like, without limiting the scope of the disclosure.

According to an exemplary embodiment, the spending activities, may include spending at specific merchant, spending at competitor merchant, monthly spending, favorite stores, merchant specific spending, brands and/or merchant stores associated with the purchases, amounts associated with the purchases and type of financial transactions associated with the purchases at corresponding on-line and/or off-line stores of the merchants. The type of purchase may include but not limited to clothing, grocery, dining, personal care, living, travel, entertainment and the like, without limiting the scope of the disclosure. The type of financial transactions may include but is not limited to cash payment, debit card payment, credit card payment and the like without limiting the scope of the disclosure. In some embodiments, based on the spending activities of the customer the system 106 updates the individualized profile of the customer and also generates a profile score.

In some preferred embodiments, the system 106 may be configured to collect activities of the customer in online social activities may referrer to, customer social influencing capabilities and/or social influencing behavior and/or social influencing activities in one or more social networking domains, networking blogs, private and/or public blogs and the like, without limiting the scope of the disclosure. The influencing capability of the customer may be identified by reviewing the number of postings and/or comments and/or reviews of the customer on the one or more social networking domains, networking blogs, private and/or public blogs and also based on number of followers to the customer on one or more social networking domains, networking blogs, private and/or public blogs and the like without limiting the scope of the disclosure. The social activities of the customer may also be collected in offline mode by sharing a coupon code through SMS, E-mail, voice conversations with merchants and/or other customers, referring other customers to a specific merchant and/or competitor merchant, sharing reviews, sharing deal information, sharing merchant information and the like without limiting the scope of the disclosure.

In some preferred embodiments, the system 106 may be configured to collect the psychological behavior of the customer. The psychological behavior of the customer may be collected by providing a questionnaire to the customer while registering with the system 106.

In some preferred embodiments, the merchants may be allowed to filter and view the individualized profiles of the customer based on the psychographic behaviour, likes and dislikes of the customer, wishlist, gender, change in behavioural patterns, education, occupation, industry and/or business, geographic location (e.g., city, country), without limiting the scope of the disclosure.

The merchants may provide the customers with individualized loyalty points and may also conduct individualized loyalty campaigns. The customers may redeem the individualized loyalty points with the merchants. The customer profile may also be updated based on number of loyalty points associated with the customer profile, type of preferred brand and category of the merchant associated with the preferred brand and the like, without limiting the scope of the disclosure.

Referring to FIG. 1B is an exemplary block diagram for collecting spending activities of customers by the system through the networked platforms. In some embodiments, the spending activities performed by the customer at merchant terminal 110 may be collected by the system 106. The system 106 may be configured to collect customer financial transaction details 158b from a financial intermediary. The system 106 may also be configured to collect customer spending activities using financial transaction alert services 156b.

As shown in FIG. 1B, in some embodiments, the customer 108 may be allowed to perform on-line transactions through a mobile 104a and/or a web browser 104a. The spending activities made by the customer 108 with the merchant terminals 110 may be collected by the system 106. The system 106 may be configured to update the spending activities of the customer 108 in the customer profile. The spending activities of the customer 108 collected by the system 106 may be used to update the profile of the customer and update the profile score of the customer. This enables the system 106, to dynamically track the spending activities of customer and evaluate the authenticity of the transactions performed by the customer. The transactions performed by the customer may be dynamically evaluated by the system 106 and may be provided to the merchants and thereby enabling the merchants to identify the preferred customers and provide privileged services.

Referring to FIG. 1B, the system 106 may also be configured to collect the approved cash transactions 109 for analyzing the spending activities of the customer 108. On performing a spending activity by the customer using cash, the customer transmits the cash payment acknowledgement to the merchant account for approving the cash transaction. The merchant authenticates the cash transaction of the customer and provides loyalty benefits or offers to the customer. Alternatively, the merchant may transmit the cash payment acknowledgement to the customer account for authenticating the cash transaction. The customer may authenticate the cash payment acknowledgement and may receive loyalty benefits or offers. The cash payment acknowledgement may include a physical billing receipt, physical invoice and the like. The customer may transmit a captured photograph of the cash payment acknowledgement as an attachment to the merchant account along with the details associated with the spending activity. Similarly, the merchant may also transmit a captured photograph of the cash payment acknowledgement as an attachment to the customer account along with the details associated with the spending activity.

FIG. 1C is a diagram 100c depicting embodiments connected to the system for creating and updating customer profile in response to customer activities. In some embodiments, the system 106 may communicate with a financial intermediary gateway 158 through a data communication interface 154 to collect the financial transactions associated with the spending activities of the customer. The financial intermediary may be referred to a bank customer holding a bank account and/or credit card and/or debit card. The financial transactions details 158b are collected by the system 106 through the network adaptor 158a and the data communication interface 154. The financial transaction details 158b of each customer may be differently identified by correlating with the details of credit cards associated with financial intermediary, details of credit card associated with financial intermediary, account number associated with the financial intermediary 158. The financial transaction details may be used in identifying the number of visits made by the customer to the corresponding merchant store, consolidated view of the types of purchases, types of purchases made by the customer with a corresponding merchant, amount associated with the purchases, frequency of purchases made by the customer in general and with a specific merchant, and the like without limiting the scope of the disclosure. Thus, the financial transaction details collected from the financial intermediary may be used to analyze the spending behavior of the customer. Based on the spending activities, the system 106 updates the customer profile and in turn updates the profile score of the customer. The customer profile comprising the spending behavior of the customer and profile score may be presented to the merchants for identifying the preferred customers.

In some embodiments, the system 106 may also be configured to collect the spending activity details using the financial transaction alerting services. The financial transaction alert services may be referred to transaction alert services provided by the credit card service provider, debit card service provider. For example the financial transaction alerting services may be referred visa alert services, MasterCard alert services, Maestro card alert services and the like without limiting the scope of the disclosure. On performing a financial transaction by the customer at merchant terminals, the financial transaction alerting gateway 156 updates the financial transaction details 156b to the system 106 through the network adaptor 156a and the data communication interface 154.

As shown in FIG. 1C, the social media gateway 160 may be configured to collect social activities 160b of the customer. The social influence activities 160b of the customer performed on one or more social networking domains and the social activities of the customer performed on the registered user account are collected by the system 106 through a data communication interface and the network adaptor. In some embodiments, the social activities of the customer may be monetized i.e. the system 106 may be configured to track the social activities of the customer performed the on one or more social networking domains and/or within the system 106 and monetize the activities by providing rewards.

In some embodiments, the system 106 may be coupled with a SMS/Email gateway 162 through a data communication interface 154. The SMS/Email gateway 162 may be configured to transmit the SMS/Email to the registered customer account and registered merchant account for the activities performed in the system 106. The merchant and the customer may receive SMS to a registered contact number and the email may be transmitted to registered email account. Furthermore, the system allows the merchant to transmit deals and loyalties offered to the preferred customer through SMS and/or Email. The system 106 collects the SMS/Emails 162b transmitted to the customer and merchant through the network adaptor 162a. The data communication interface may be referred as any telecommunication network configured to exchange data between the system 106 and the financial intermediary gateway 158, the financial transaction alerting gateway 156 and the SMS/Email gateway 162. The system 106 allows the merchant to transmit deals and loyalties offered to the preferred customer as notifications through web interface 104a and/or mobile interface 104b.

According to an exemplary embodiment, the customer may be provided with a universal loyalty card for registering with the system 106. The universal loyalty card may be associated with the profile of the customer with a customer identification code. The universal loyalty card may be updated with the individualized loyalty points in response to the spending activities performed across multiple merchants. The individualized loyalty points may also be provided for a spending activity performed with a specific merchant or with multiple merchants. The individualized loyalty points may be provided with the system 106 and/or by a merchant for performing a spending activity or by a competitor merchant. The individualized loyalty points associated with the universal card may be redeemed universally with the merchants, with a specific merchant who provided the individualized loyalty points, with a competitor merchant. In another aspect, the individualized loyalty points may be redeemed with the merchants, with a specific merchant who provided the individualized loyalty points, with a competitor merchant without the usage of the universal loyalty card.

The merchants may provide the individualized loyalty points in response to the spending activities of the customer received from financial intermediary and/or financial transaction alert service. The merchants may also provide additional individualized loyalty points for the preferred customers. The preferred customers may also receive privileged services by redeeming the individualized loyalty points with the merchants. The merchants may also identify the preferred customers by viewing the individualized loyalty points associated with the universal card. The points associated with the universal card may be associated with the profile of the customer for updating the profile score.

According to an exemplary embodiment, the customers may also be provided with the individualized loyalty points provided by the merchants without being performing any spending activity, by filling a questionnaire provided by the merchant and based on a current and/or future spending commitment with the merchant, by referring merchants to friends and/or other affiliates, without limiting the scope of the disclosure. The questionnaire may be related to knowing the spending behavior or personal preferences of the customer. The individualized loyalty points associated with the universal loyalty card may be redeemed completely or partially. The redemption process may be any suitable redemption options known in the art.

Referring to FIG. 1D is a diagram 100D depicting the system for creating and updating customer profile in response to customer activities. The preferred embodiments of the system 106 may include software components or hardware components or combination thereof. The system 106 may include a customer registration unit 112 for enabling customers to register with the system 106. As shown in FIG. 1D, a merchant registration unit 114 included in the system 106 may be configured to enable the merchants to register with the system 106.

As shown in FIG. 1D, a customer score generating unit 116 may be configured to generate a score for each individual customer based on the activities of the customer. The generated score may be updated in the customers profile and may be made available to the merchant in recognizing the preferred customers. The deal generating unit 118 included in the system 106 may be configured to provide deals to the preferred customers.

Also as shown in FIG. 1D, the system 106 may also include a customer filtering unit 122. The customer filtering unit enables the merchant to filter and view the profiles of the customers based on the customer profile for categorizing and identifying the preferred customers. The system 106 may also include a merchant filtering unit 124 for enabling the customers to filter the merchants based on one or more parameters. The one or more parameters may include, but not limited to location of the merchant, services offered by the merchants, customer ratings, deals offered by the merchant and the like. Further, the system 106 may also include a user prioritizing unit 120 for enabling the merchants to prioritize the filtered customers for providing privileged services. For example among the filtered customers, the highest profile score customer may be provided enhanced privileged services.

In some embodiments, the system 106 may further include a customer profile gamifying unit 126. The customer profile gamifying unit 126 may be configured to dynamically build customer profile. The profile score scale depicts the current profile score of the customer. The profile score of the customer may increase based on the activities of the customer. For example by setting up the profile the customer may earn 200 points, by sharing information the customer may earn 200 points, by performing a spending activity the customer may earn 200 points, and by spending at a merchant also the customer may earn 200 points. In some embodiments, based on the score the customer may be provided with badges including but not limited to Activity Czar, Social Mogul and Review Prince.

Also as shown in FIG. 1D, the system 106 includes a loyalty generating unit 128 configured to generate loyalties by the merchants. The merchants may generate loyalties to the preferred customers based on activities of the customer. For example, the loyalties may be provided to the customer in response to performing a spending activity with the corresponding merchant and/or competitor merchant.

As shown in FIG. 1D, the system 106 may also include a transaction based review authenticating unit 130. The transaction based review authenticating unit 130 enables the customers to write authenticated reviews. The transaction based review authenticating unit 130 generates a review authentication code in response to the user performing a spending activity with the merchant. The generated authenticated code is transmitted to as SMS/Email to the merchant account. The customer while providing a review to the merchant, the transaction based review authenticating unit 130 prompts the customer to enter the generated authentication code to complete the process of review writing. This enables the merchants to collect authenticated reviews from the customers.

As shown in FIG. 1D, the system 106 may also include a review collecting unit 132 for collecting the reviews provided by the multiple customers. The reviews authenticated by the transaction based review authenticating unit 130 are collected by the review collecting unit 132 may be provided to the merchant. The reviews provided by the customers may be viewed by the merchant through a review viewing unit 134.

In some embodiments, the system 106 may also include a geo-fenced customer identifying unit 136. The geo-fenced customer identifying unit 136 enables the merchants to locate and identify the presence of customers in a specified geo-fenced location. The system 106 may also include a geo-fenced merchant identifying unit 138. The geo-fenced merchant identifying unit 138 enables the customers to identify the merchants available in the specified geo-fenced location.

Further as shown in FIG. 1D, the system 106 may also include a customer data collecting unit 140. The customer data collecting unit 140 may be configured to collect activities of the customer to build the customer profile and update the profile of the customer.

As shown in FIG. 1D, the system 106 may also include customer activities analytics generating unit 142. The customer activities analytics generating unit 142 may be configured to generate pictorial representations of the spending activities performed by the customer. For example, for the spending activities of the customer activities analytics generating unit 142 may generate a pie-chart depicting details of the purchases, types of purchases, details of the merchant with whom a purchase is made and the like, without limiting the scope of the disclosure.

In some embodiments, the system 106 may include customer activities analytics viewing unit 144. The customer activities analytics viewing unit 144 enables the merchants to view the pictorial representations of the spending activities of the customer.

The system 106 may also include a customer database unit 148. The customer database unit may be configured to store the created profile of the customer, spending activities of the customer, generated analytics of the customer, reviews provided by the customer and the like.

In some embodiments, the merchant profile, services offered by the merchant, reviews provided to the merchant by each individual customer and the like may be stored in a merchant database 146.

Referring to FIG. 1E is a block diagram 100e for building a customer profile. As shown in FIG. 1E, without limiting the scope of the disclosure, the customer profile 101 may be built based on demographic and geographic details 103, online and offline social activities 105, psychographic behavior 107, spending activities 109, loyalty points 111, system activities 113 i.e., activities performed in the system 106, customer-to-merchant/merchant-to-customer relational data 151, and income sources and credit data 153.

FIG. 1F is a block diagram 100f for customizing profile of the customer with respect to the specific category of a merchant. As shown in FIG. 1F, considering an exemplary category of merchant to be restaurant and dining category, the customer profile may be customized and provided to the restaurant and dining category. The customized profile may include transactions with merchant and other similar merchants 125, check-in with the merchant and other similar merchants 127, reviews at merchant location and competitor merchant locations 129, customer grade 131, loyalty rank 133, spending ability 135, average spending abilities 137, favorite restaurant and dining locations 139, social networking domain activities 141, customer grade 143 provided by the system 106, and referral grade 145 and profile picture of the customer 147 and profile name 149.

FIG. 1G is a block diagram 100g for generating loyalty points by the merchants in response to the customer's activities in campaigns. The system 106 allows the merchants to conduct campaigns which may include but not limited to, demographic and geographic campaigns 115, social networking domain campaigns 117, system activities 113, psychographic behavior activity campaigns 121, spending activity (activities with the merchant and with competitor merchant) campaigns 119, and loyalty campaigns 123. The merchant may be allowed to conduct the campaigns for the customers in the system 106, based on the activities performed by the customer in campaigns the merchant may provide deals, loyalty points, reward points and also provide privileged services. The profile of the customer 101 is updated based on the activities of the customer in the campaigns.

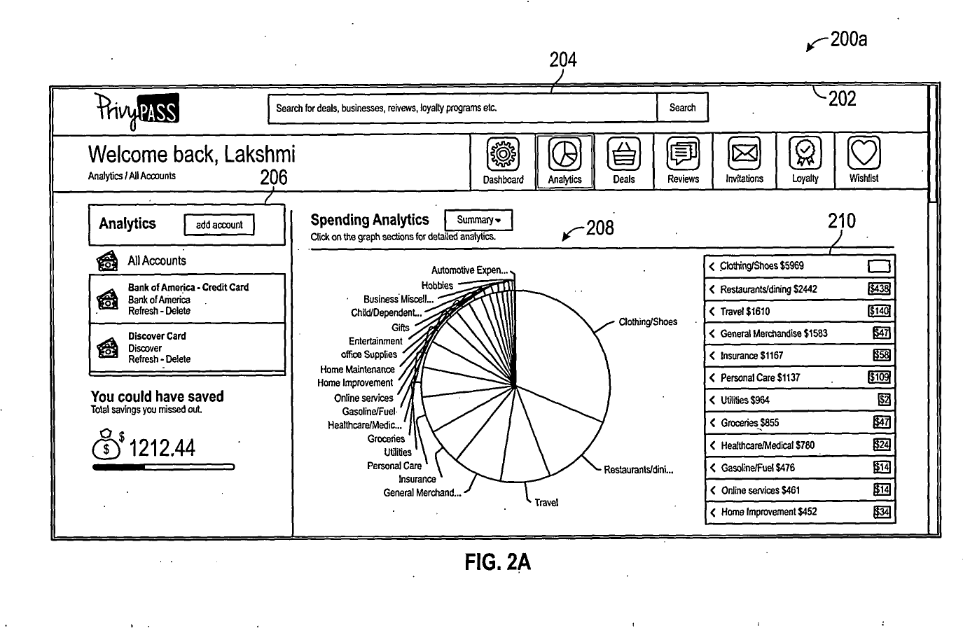

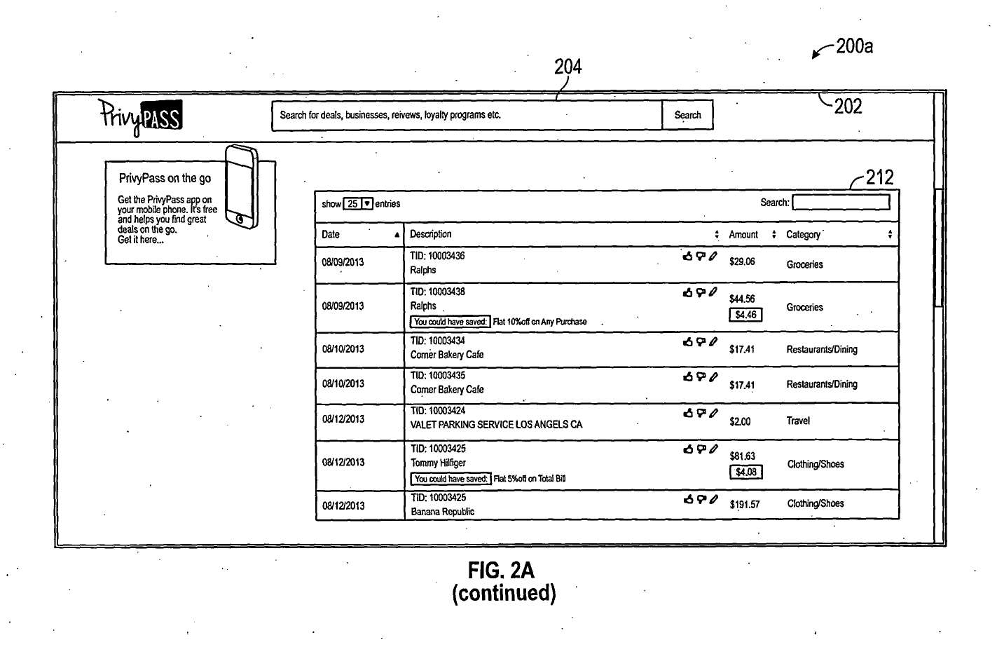

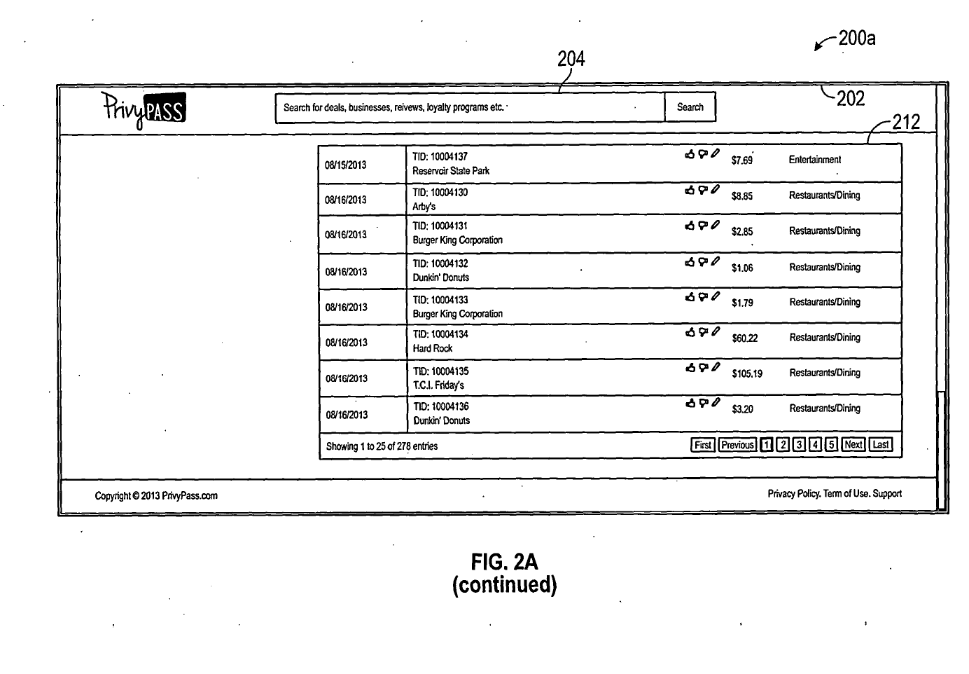

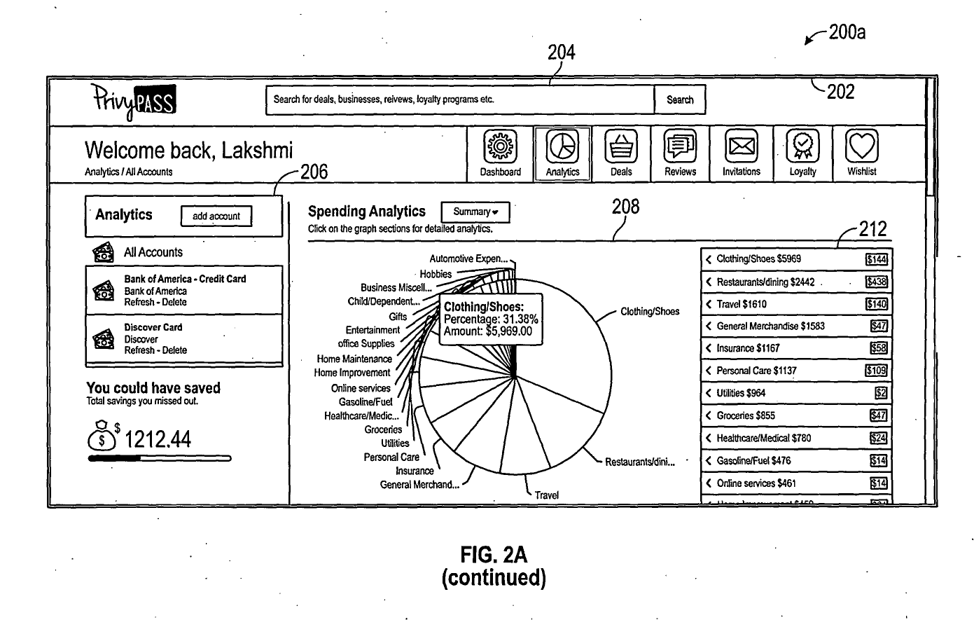

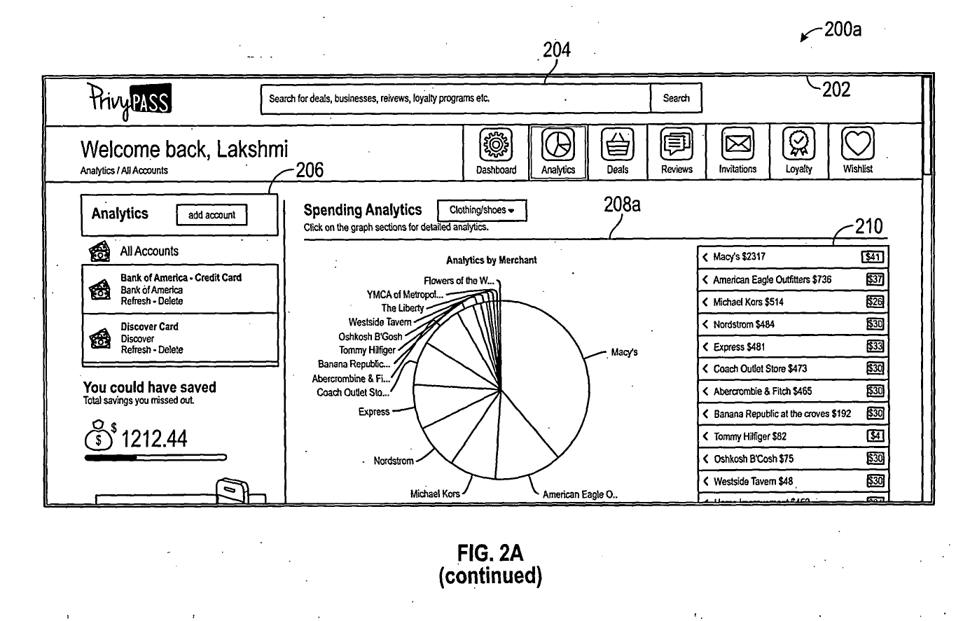

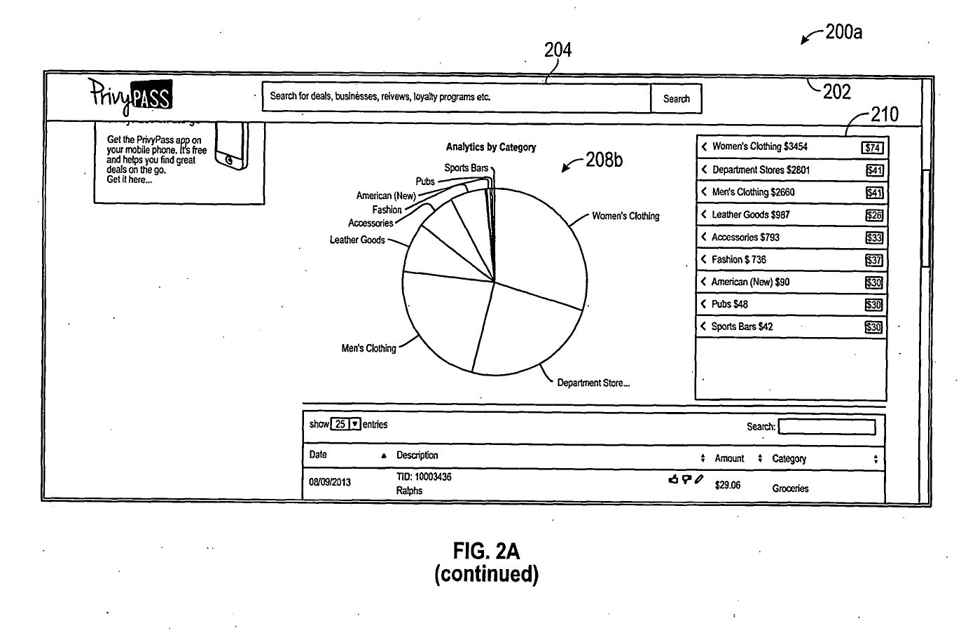

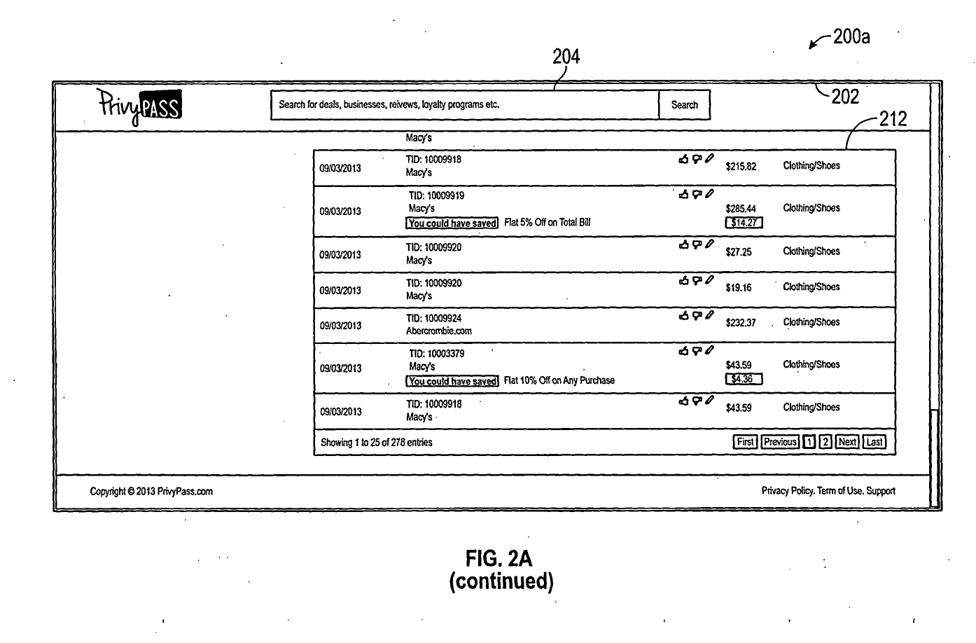

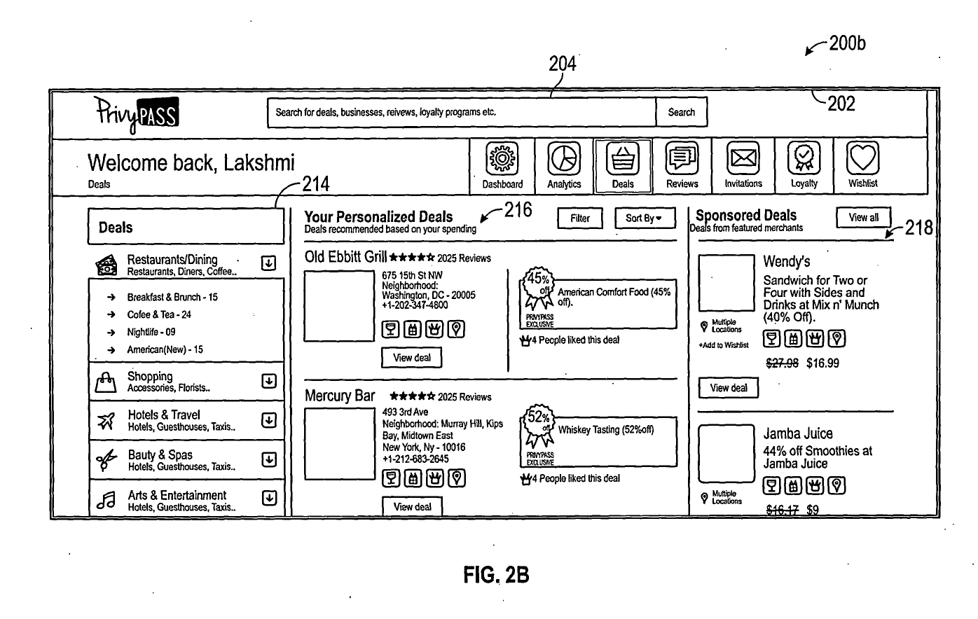

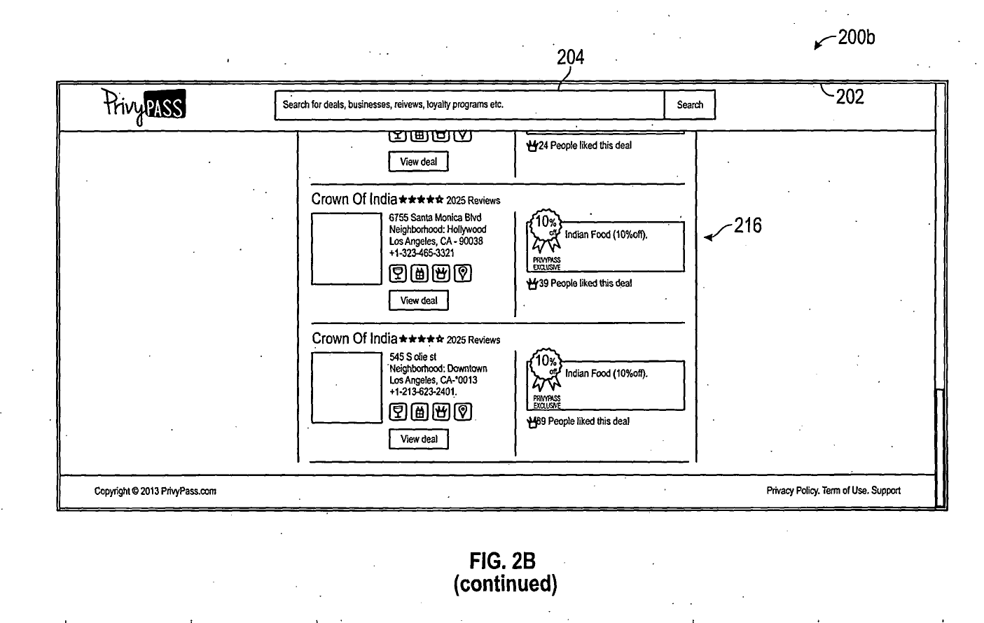

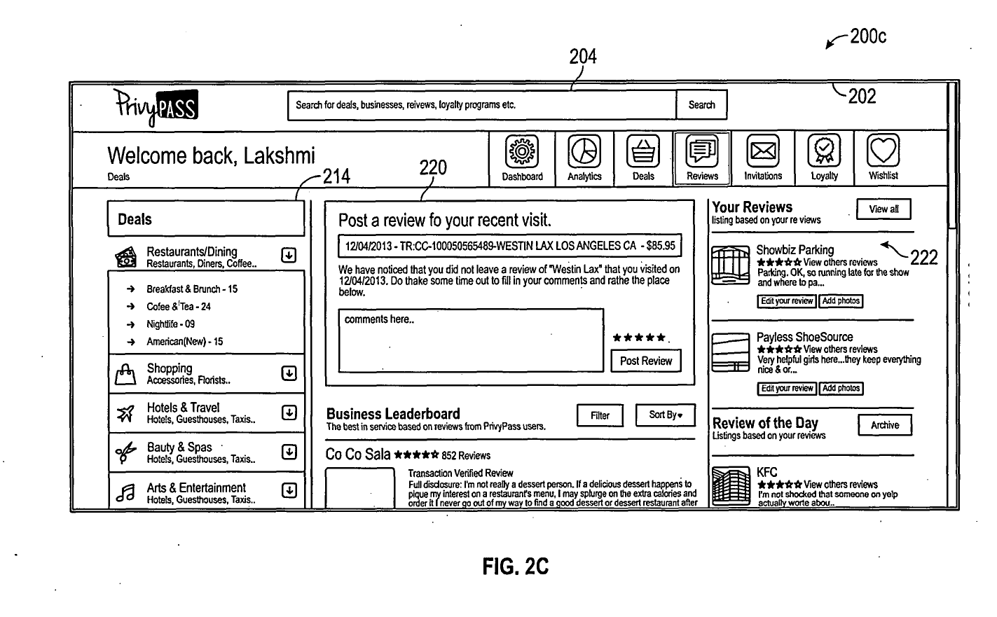

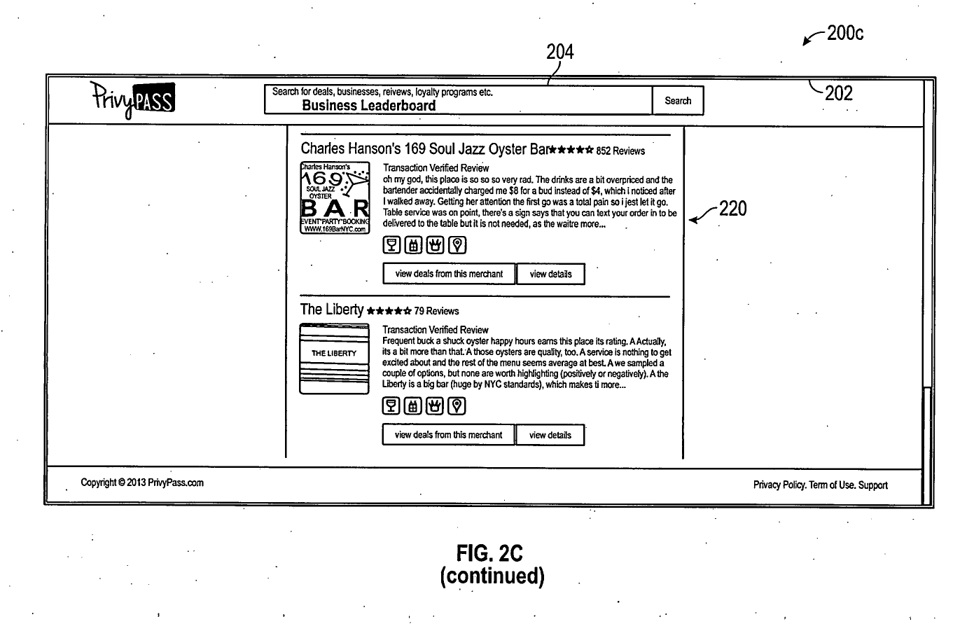

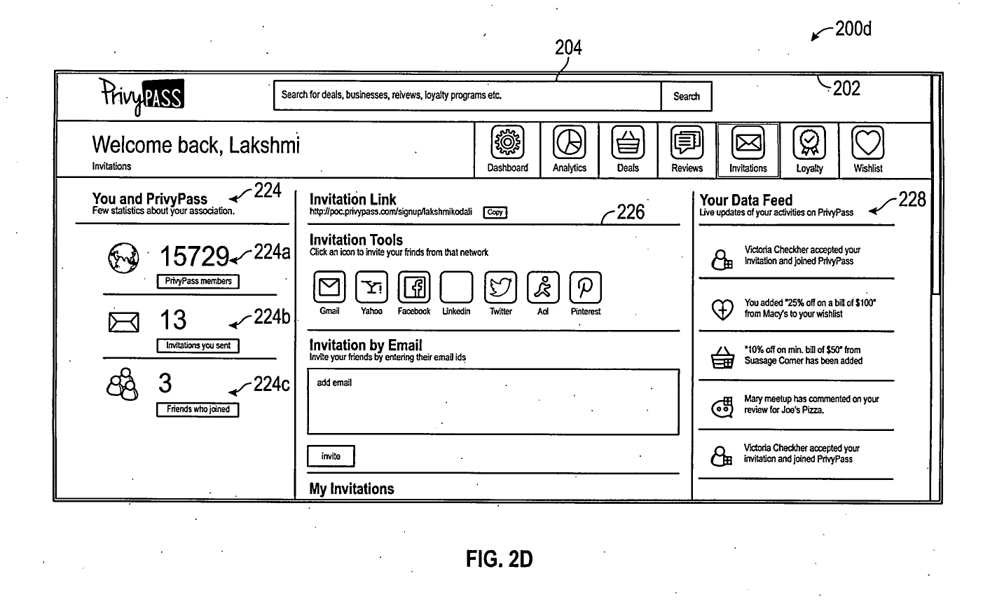

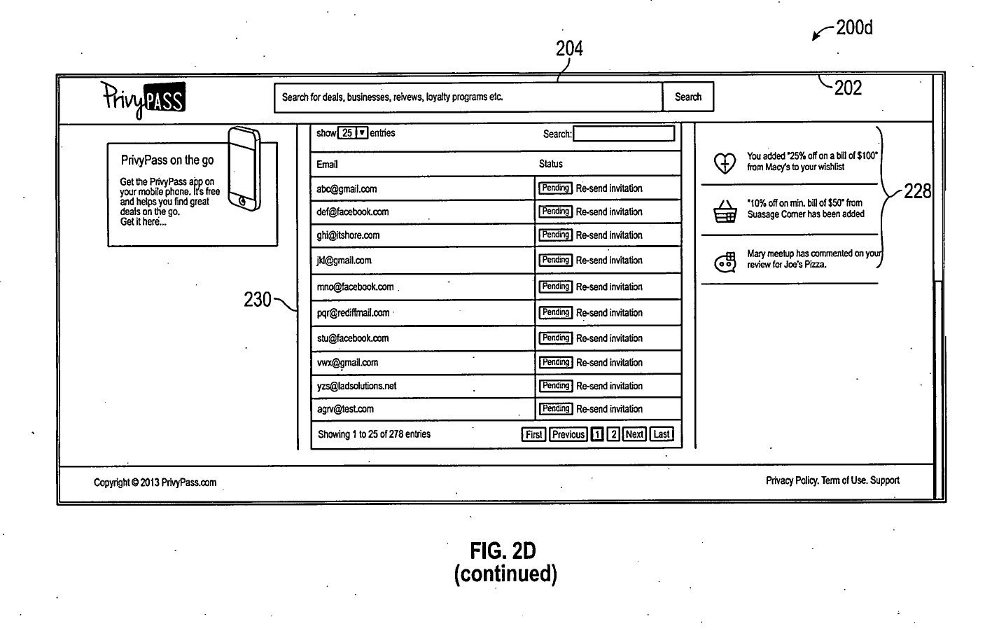

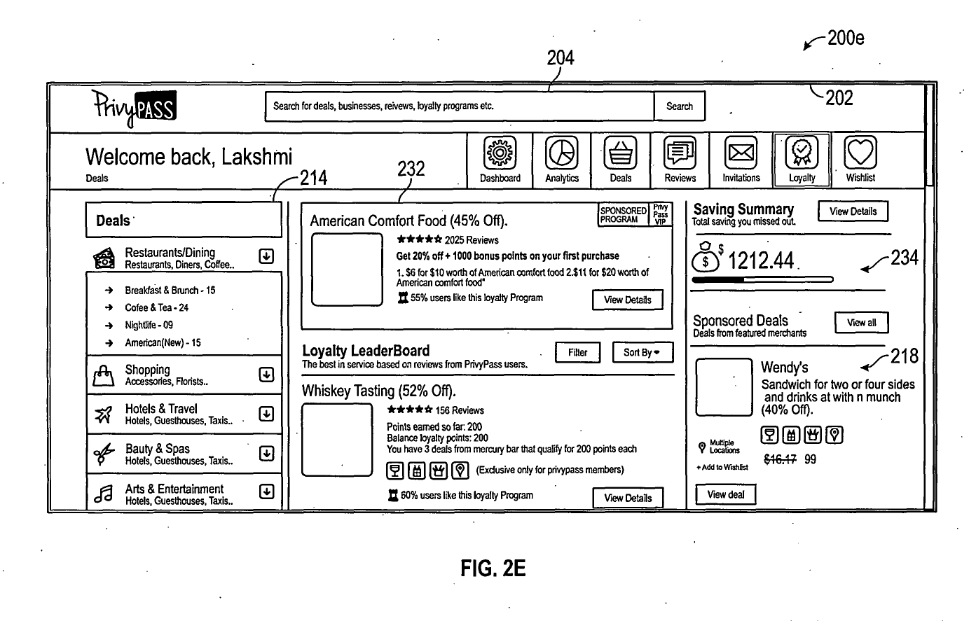

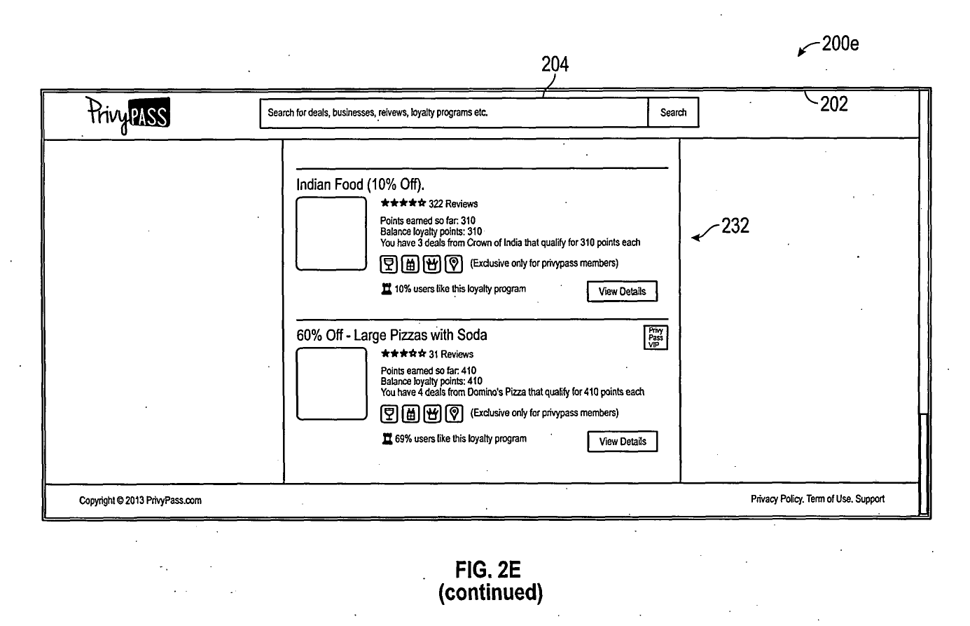

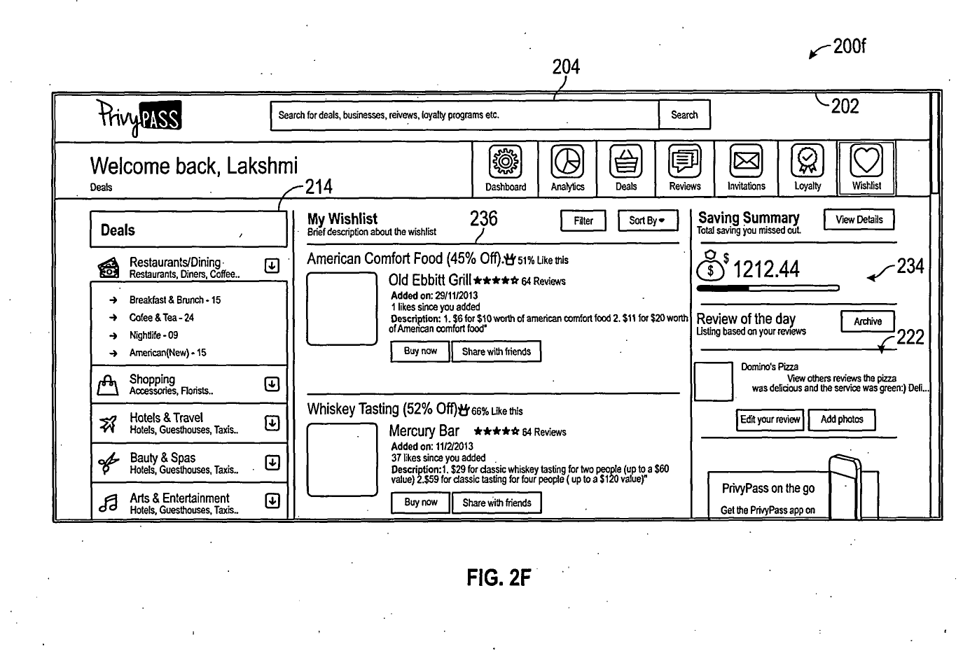

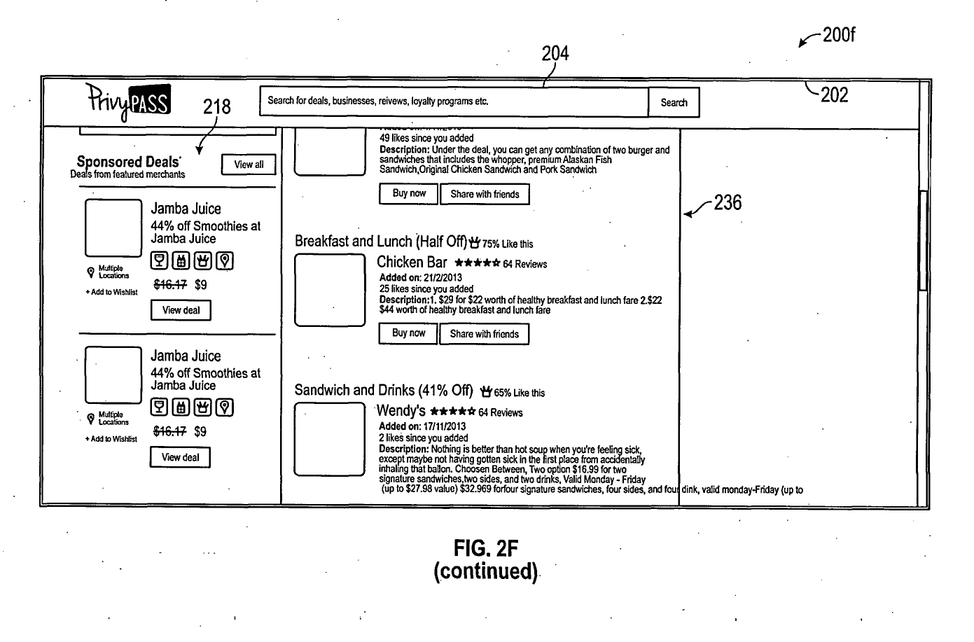

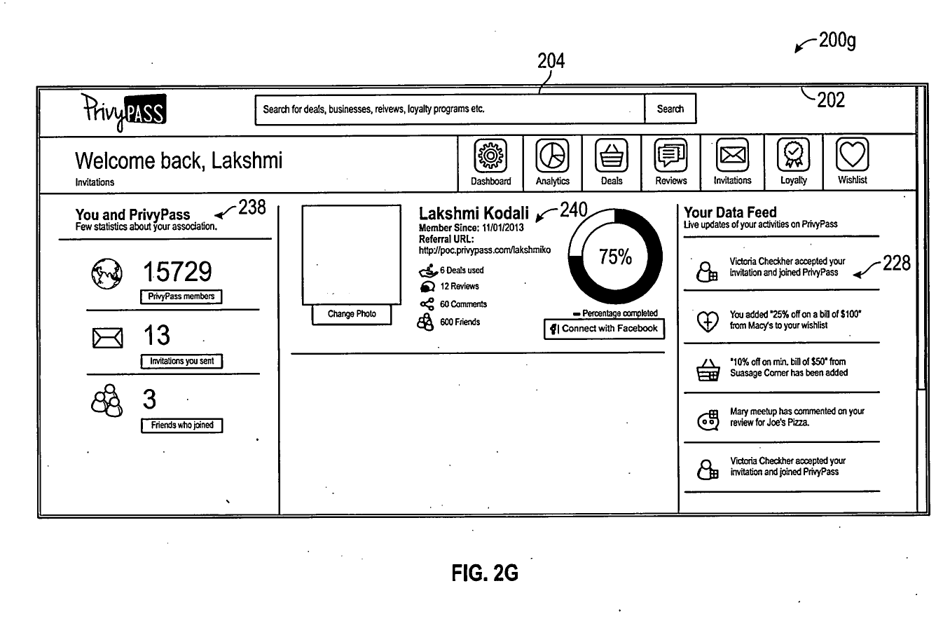

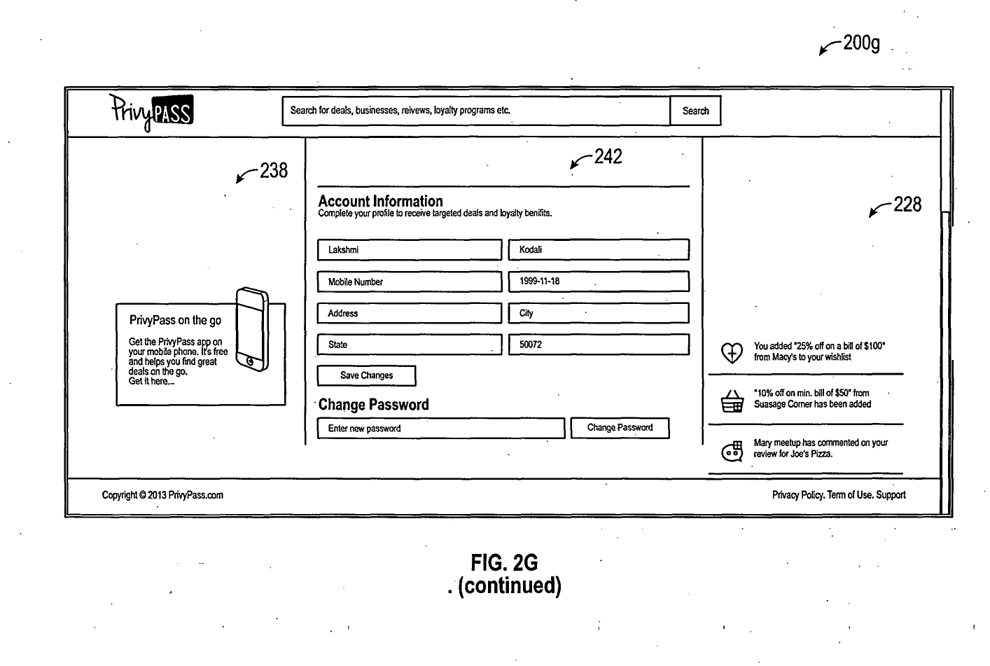

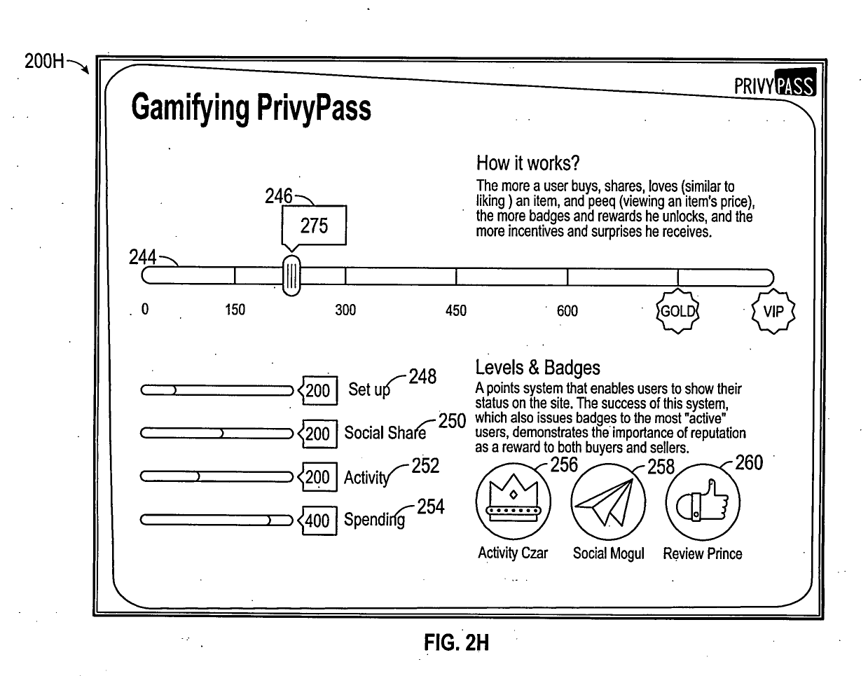

FIG. 2A is a diagram 200a illustrating an exemplary user interface displaying customer spending activities. The spending activities of the customer collected from the financial intermediary gateway and the financial transaction alerting gateway are used to understand the spending behaviour of the customer and generate pictorial representation of spending activities. In some embodiments, the user interface 200a includes a header 202 along with a search bar 204 used to search deals, businesses, reviews, loyalty programs and the like without limiting the scope of the disclosure. The user interface 200a may be configured to display the complete spending activities graph 208 of the customer as a summary. The spending activities graph may represent different types of spending details which may include but are not limited to automotive expenses, hobbies, business miscellaneous, child/dependent expenses, gifts, entertainment, office supplies, home maintenance, home improvement, on-line services, gasoline/fuel, health care/medical, groceries, utilities, personal care, insurance, general merchandise, travel, restaurants/dining and clothing/shoes.

Also as shown in FIG. 2A, the user interface 200a may also be configured to display the amount spent for each category as a list 210. For example, the list includes amount spent for clothing/shoes is $5969 and the amount saved can be $144, for restaurants/dining amount spent is $2442 and amount saved can be $438, travel amount spent is $1610 and saved can be $140 and the like. The other side 206 of the graph 208 may also be configured to display accounts used for payment of the purchased products and also the total amount saved by the customer. The accounts may include but not limited to credit card and/or debit card (for example bank of America credit card, discover card) and the like. The numeral 212 displays the list of description for the each individual purchase. The list may include date, description including transaction id number, likes or dislike, amount, category of purchase.

Further as shown in FIG. 2A, in some embodiments, the spending activities graph 208 may also be further divided for displaying the category, percentage of amount spent and amount spent. The user interface 200a also displays the graph 208a of the merchants for the selected category and may also display the list 210a of the different merchant names of the selected category. For example if the selected category is clothing/shoes the corresponding graph related to merchants of the graph is displayed and the purchase made with the corresponding merchant is listed as 210. The user interface also displays the graph 208b for the spending activities by category of clothing/shoes i.e., for women clothing, sports bars, pubs, American (new), fashion, accessories, leather goods, men's clothing and the like, without limiting the scope of the disclosure.

Also further as shown in FIG. 2A, the graph 208b may also display the list 210b of the different categories and the amount spent for the specified category. For example, women's clothing spent amount as $3454 and amount saved can be $74, department stores spent amount is $2801 and amount saved can be $41 and the like. Also the detail of the purchase for the selected category is displayed at 212 with date, description, likes or dislikes, amount and type of category.

FIG. 2B is a diagram 200b illustrating an exemplary user interface of deals provided to the customer. The user interface 200b may be configured to display individualized deals offered by various merchants at 216. The individualized deals offered by merchant for different categories may be displayed by selecting a specific category from a list of categories 214 on the user interface 200b. Thus based on the selected category the individualized deals corresponding to the category may be displayed at 216. The individualized deals offered may be displayed along with the reviews, percentage-off, location and the like without limiting the scope of the disclosure for enhancing the interest of the customer to accept the deal.

Also as shown in FIG. 2B, the user interface 200b may also be configured to display the deals sponsored by each individual merchant of different categories of sponsored deals at 218. The sponsored deals 218 may not be restricted to current selection of category, but also may be dependent/independent on the spending activities of the customer.

FIG. 2C is a diagram 200c illustrating an exemplary user interface of reviews provided by the customer. The user interface 200c may also be configured to display the reviews provided the customer at 220. The system 106 authenticates the customer to write review for the visit of the store/service provided by the merchant and also displays the reviews provided by the customer as list at 222 on the user interface 200c. The reviews displayed at 222 may include but is not limited to the past reviews, days ago and months ago, which can be further modified by clicking the edit review button or by adding the photos/pictures/images and the like.

FIG. 2D is a diagram 200d illustrating an exemplary user interface of invitations to be sent by the customer. The user interface 200d may to display the statistics of the customer and the system 106 at 224. The statistics may include the members 224a included in the system 106, invitations sent by the corresponding customer at 224b, friends joined at 224c and the like, without limiting the scope of the disclosure.

As shown in FIG. 2D, the user interface 200d displays the process of sending invitations to multiple friends at 226 through a link or by directly inviting friends. In some embodiments, the customer can copy and paste the provided link for the each individual friend for inviting. In some embodiments, the invitation can be sent by selecting any of the invitation tool from the list of tools (e.g., gmail, yahoo, facebook, linkedin, twitter, AOL, pinterest). In some embodiments, the invitation can also be sent by manually adding the email id of the each individual friend. Further the user interface 200d also displays the live updates of the activities of the customer at 228. The activities may include but may not be limited to invitations accepted by friend, the amount saved from the bill is added, comments for the reviews and the like. Also the user interface 200d clearly displays the invitation list 230, which includes the email id of the friends and status of their response for invitation.

FIG. 2E is a diagram 200e illustrating an exemplary user interface describing loyalties provided by the merchants in response to the spending activities of the customers. The loyalty leader board 232 may be configured to display the various loyalty programs of the merchants of different types. Also the loyalty leader board 232 may also display the savings summary 234 describing the complete total saving missed by the customer along with the other details if required. The sponsored deals 218 from featured merchants may also displayed as the savings summary 234. The merchants may initiate individualized loyalty campaigns for the preferred customers. The individualized loyalty campaigns and the associated benefits may be displayed on the profile page of the customer. The merchants may also provide additional reward points in response to activities of the customer in the individualized loyalty campaigns. The activities of customer may include but not limited to, spending activity with the merchant and/or competitor merchant, check-in to the merchant store, writing a review to the merchant, referring friends to the merchant, sharing on the social networking platforms and the like.

FIG. 2F is a diagram 200f illustrating an exemplary user interface of wishlist of customers. The user interface 200f displays the wish list of 236 of customers. The wishlist may represent information but is not limited to the merchant store, added date, likes provided to the merchant, description of the merchant and the reviews of the merchant. The merchant added in the wish list can be shared with any friends or used for present purchases. Also the user interface 200e may also represent the savings summary 234 describing the complete savings of the customer till date and present day reviews provided by the customer 222.

Also as shown in FIG. 2F, the user interface 200f may include the list of categories 214 to be selected for viewing the specified deals/offers of the selected category. The deals sponsored 218 to the customer may also be displayed on the user interface 200f as a notification.

FIG. 2G is a diagram 200g illustrating an exemplary user interface displaying profile of the customer. According to preferred embodiments of the present disclosure, the user interface 200f may display the profile of the customer 240 including the details such as member since, referral URL, deals used, reviews, comments and friends and also the percentage of the profile, without limiting the scope of the disclosure.

As shown in FIG. 2G, the account information 240 may also displayed along with profile details such as first name, last name, and mobile number, date of birth, address, city, state and zip code. The interface may display the statistics 238 of the system 106 and the customer including the display of activities 228 performed by the customer.

Referring to FIG. 2H is a diagram 200h depicting an exemplary user interface for gamifying (also referred as improving the profile score) of the customer. The profile score scale 244 depicts the current profile score 246 of the customer. The profile score of the customer may increase based on the spending activities. For example by setting up the profile 248 the customer may earn 200 points, by sharing information 250 the customer may earn 200 points, by performing an activity 252 the customer may earn 200 points, and by spending at a merchant 264 also the customer may earn 200 points. In some embodiments, based on the score the customer may be provided with badges including but not limited to Activity Czar 256, Social Mogul 258 and Review Prince 260.

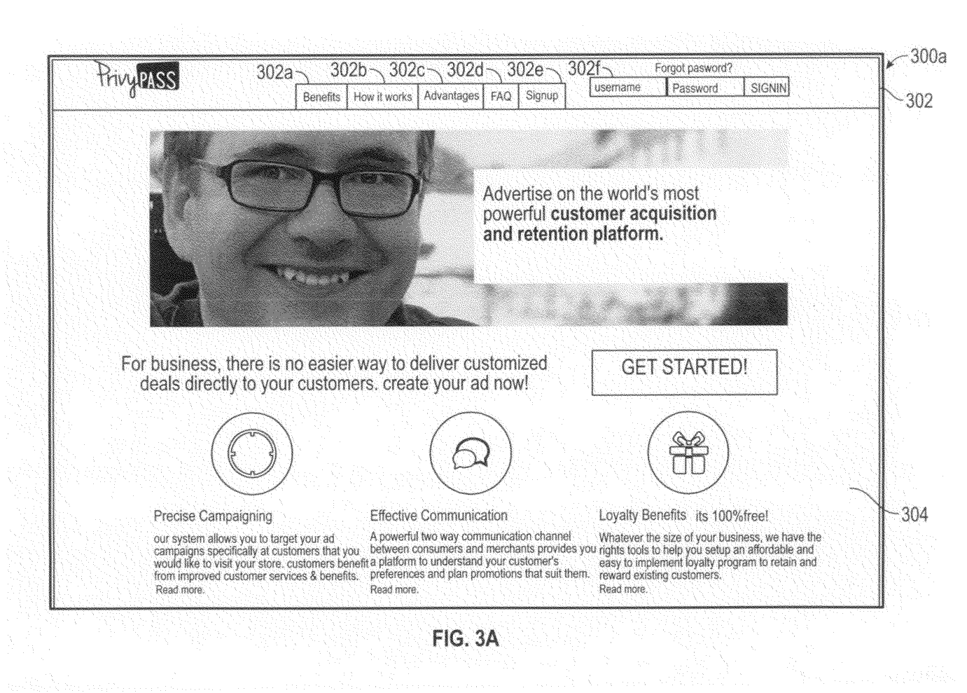

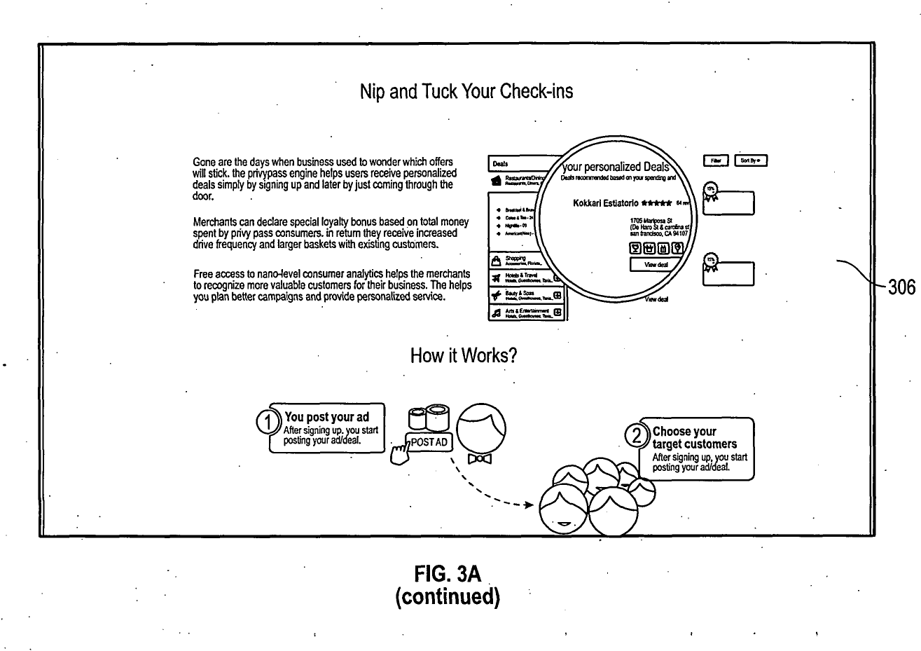

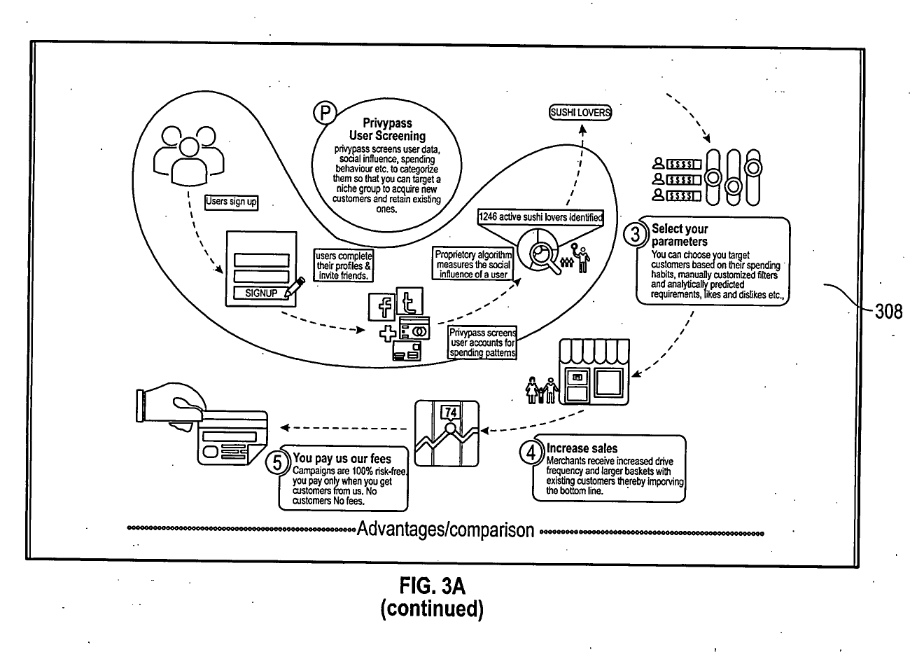

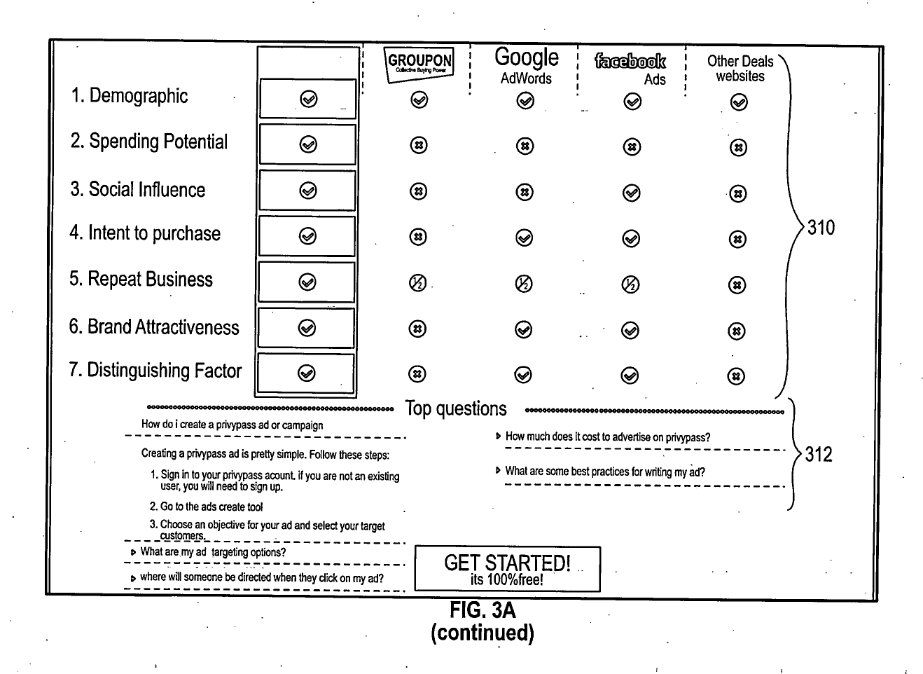

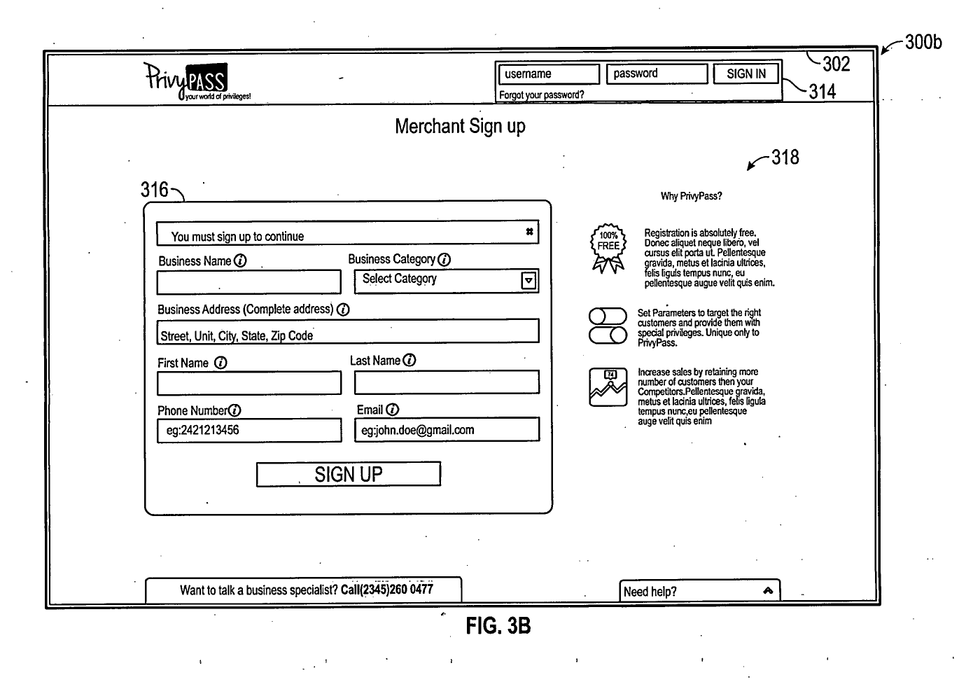

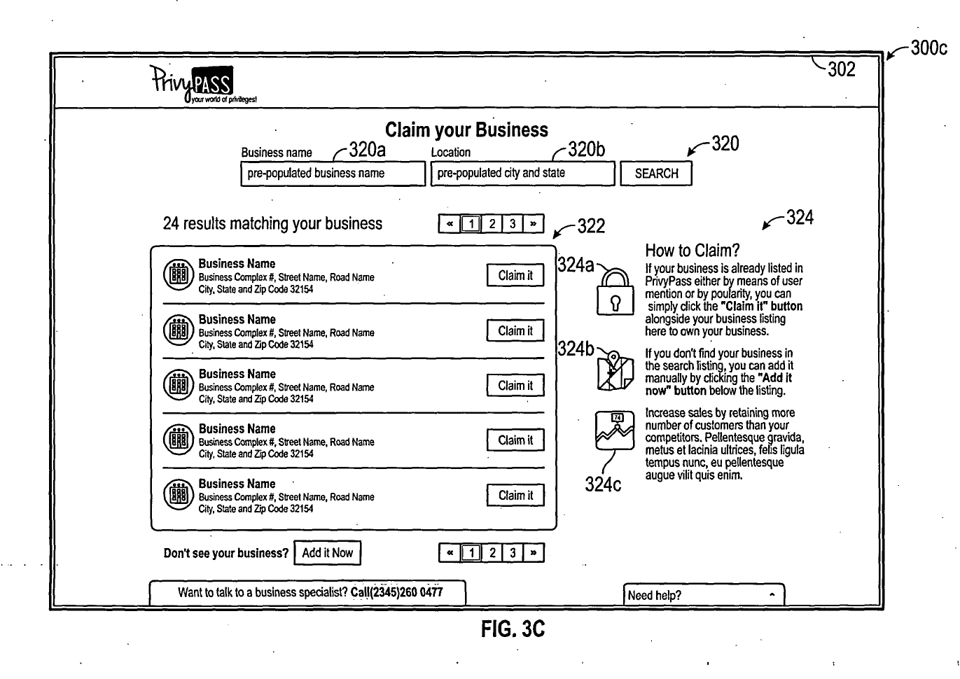

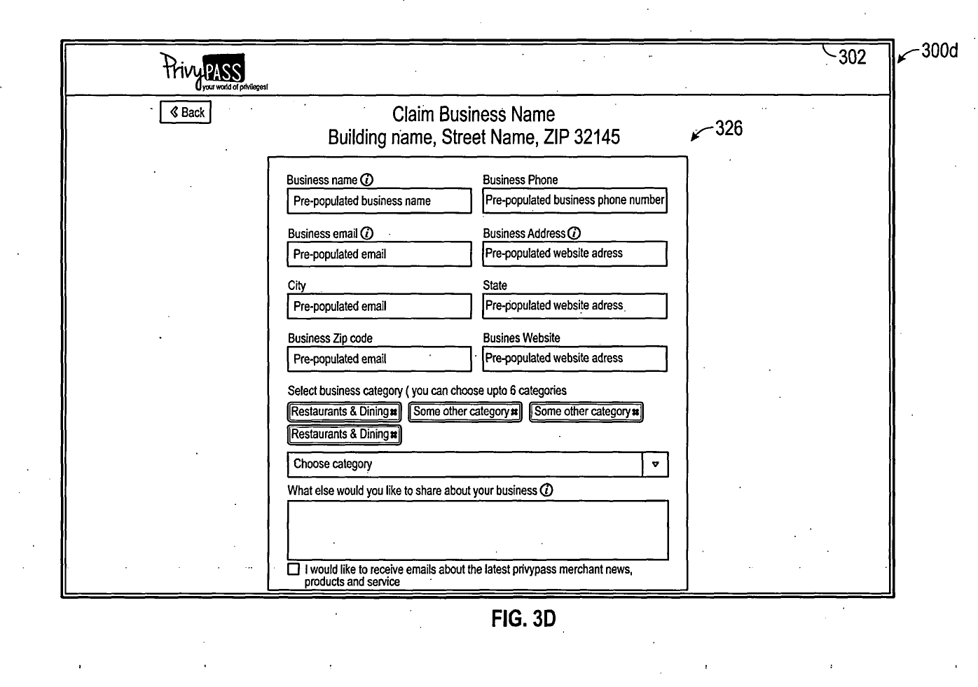

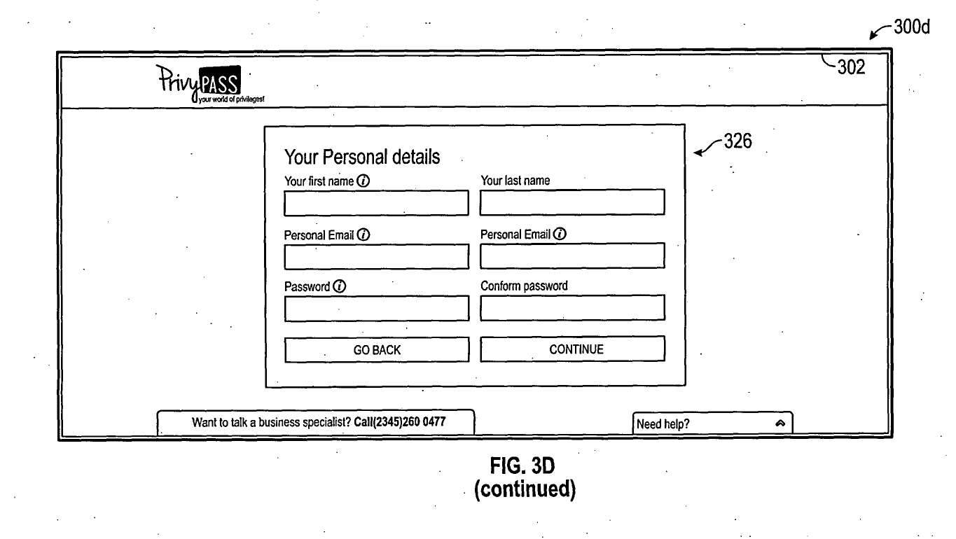

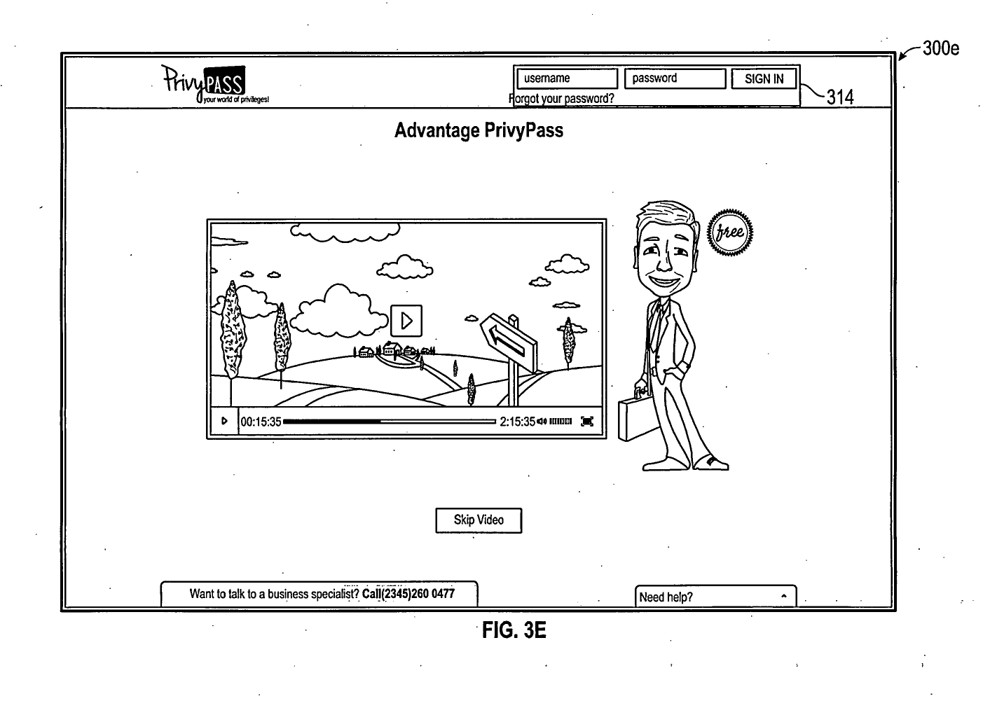

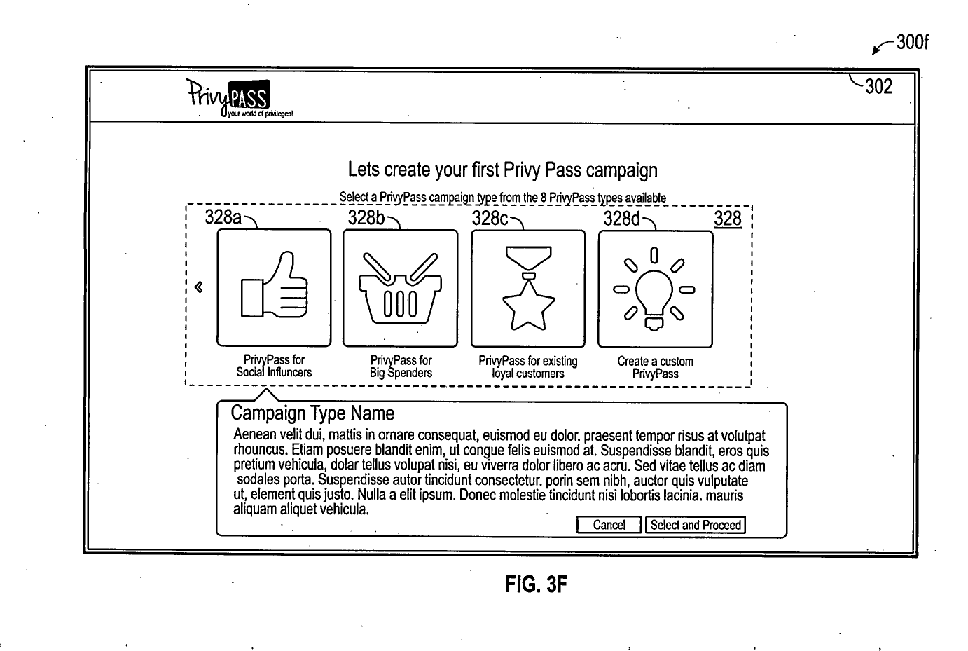

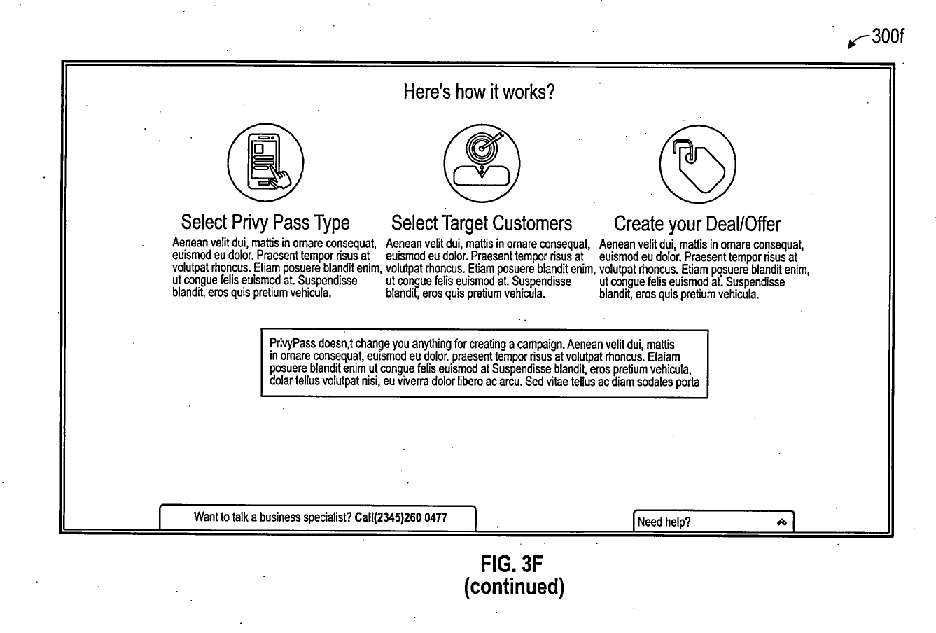

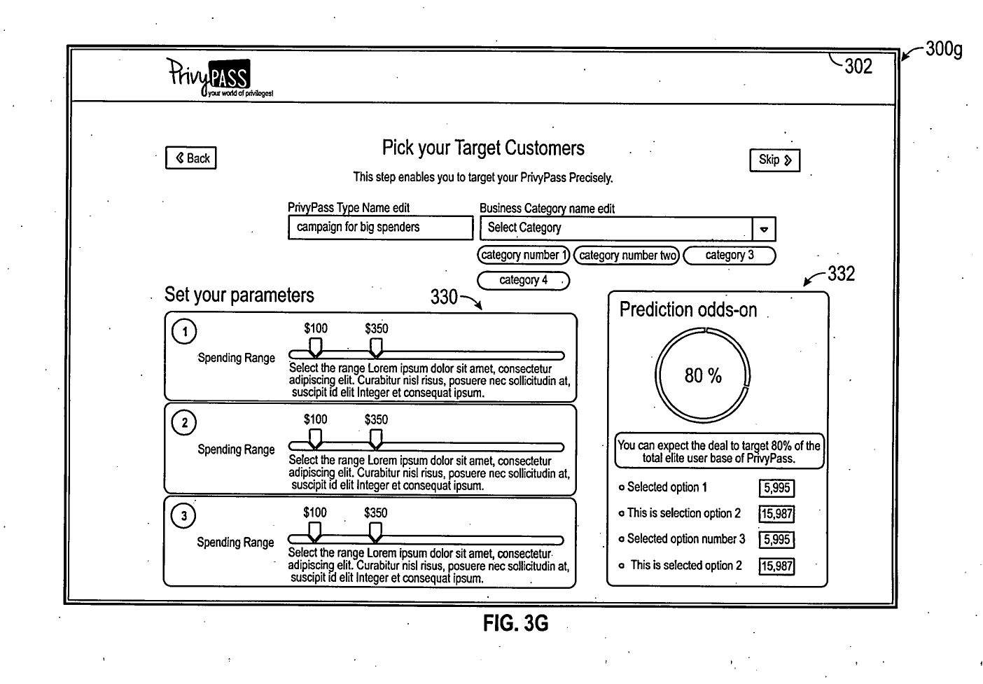

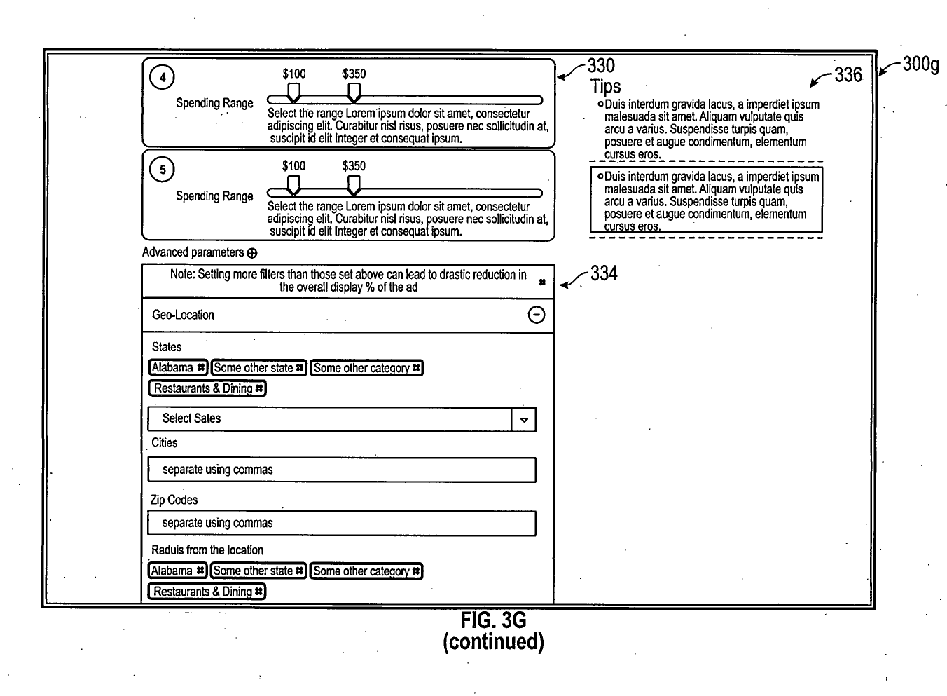

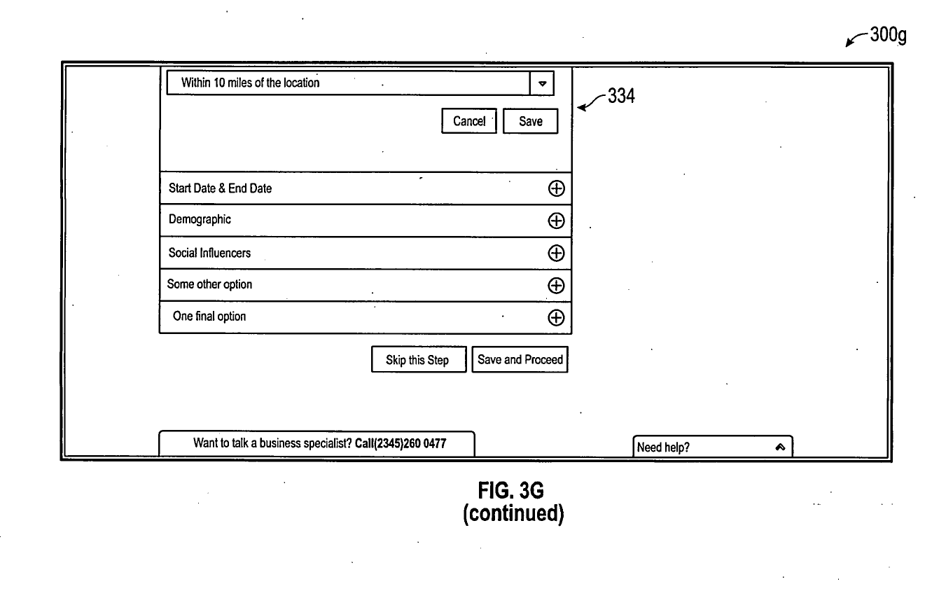

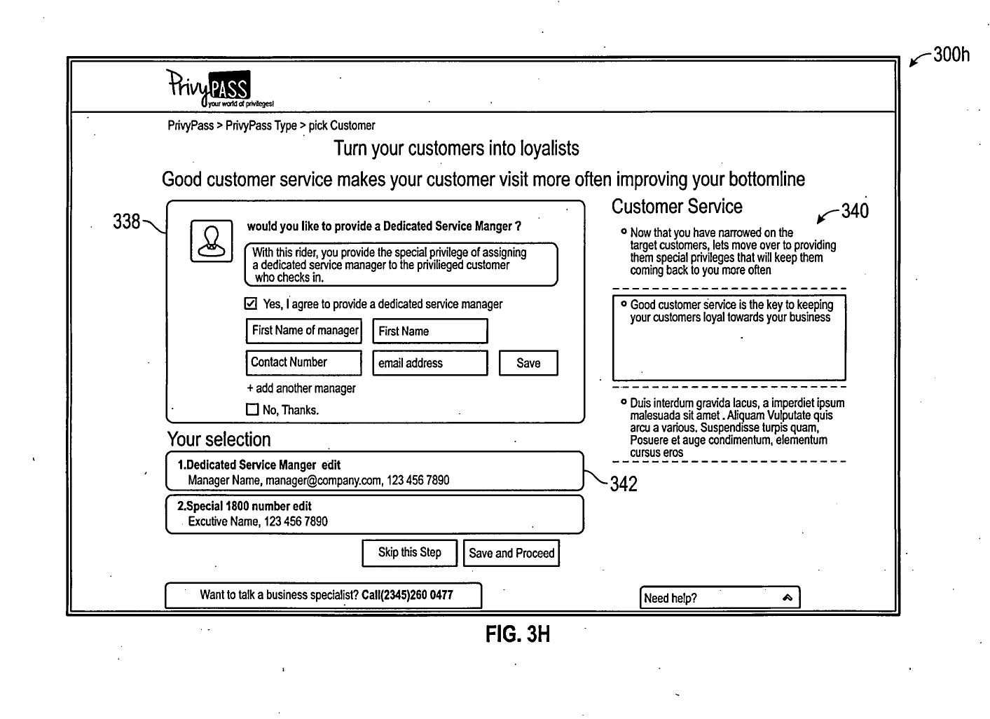

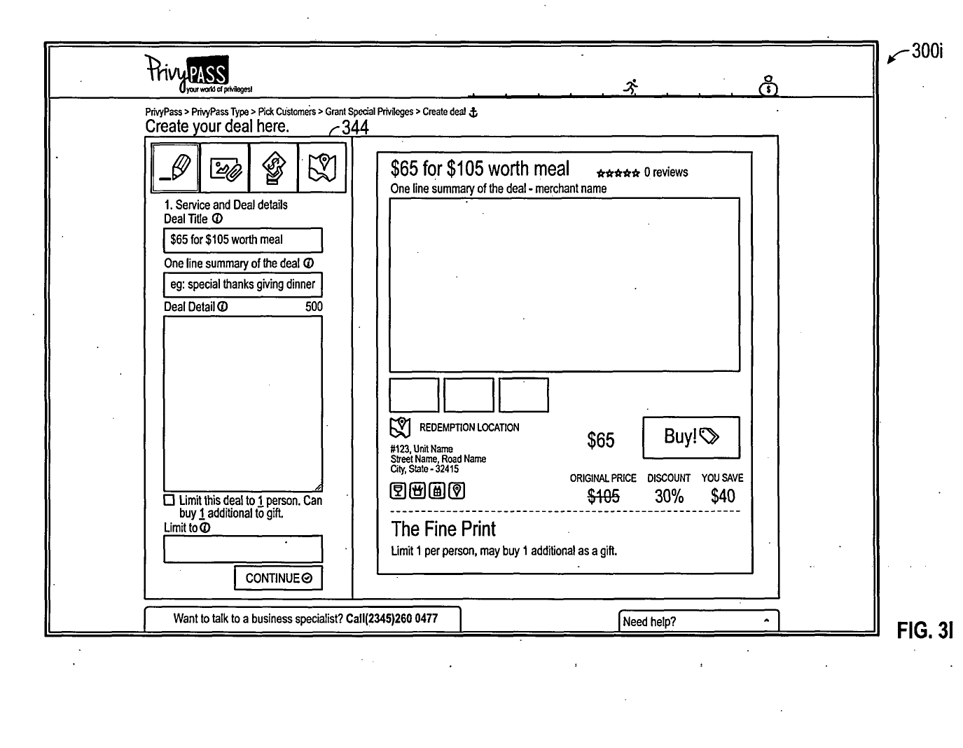

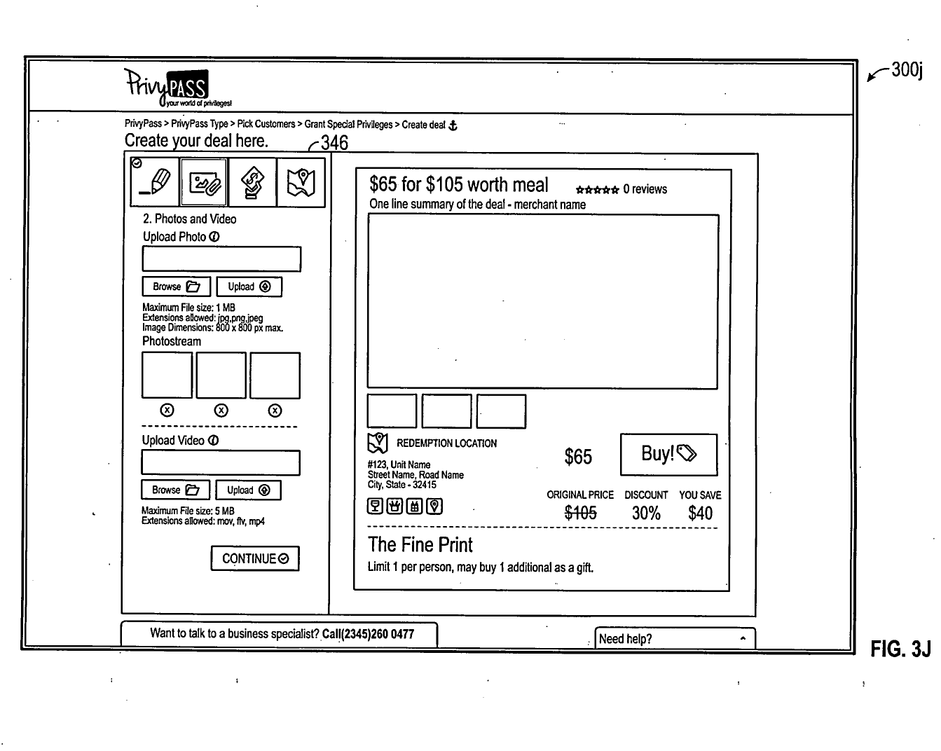

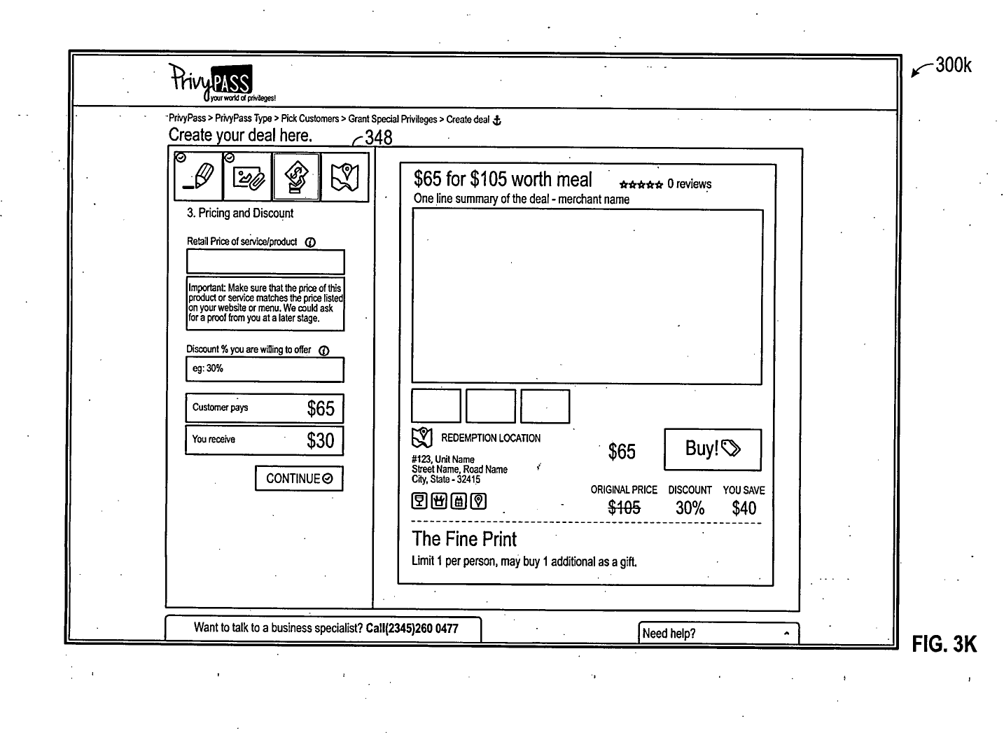

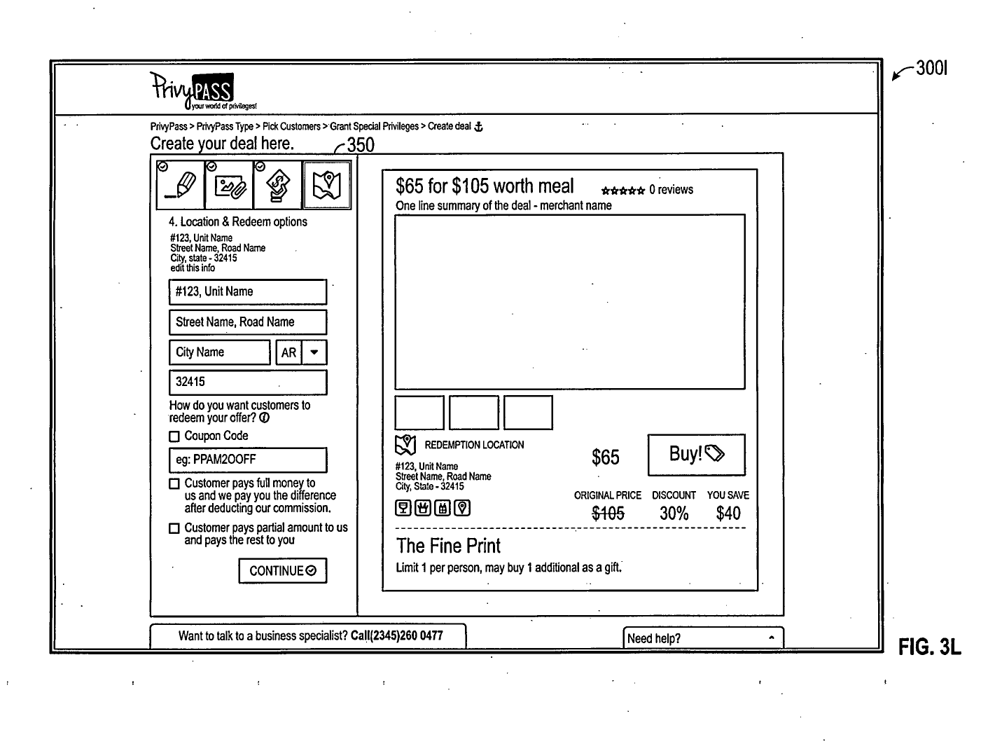

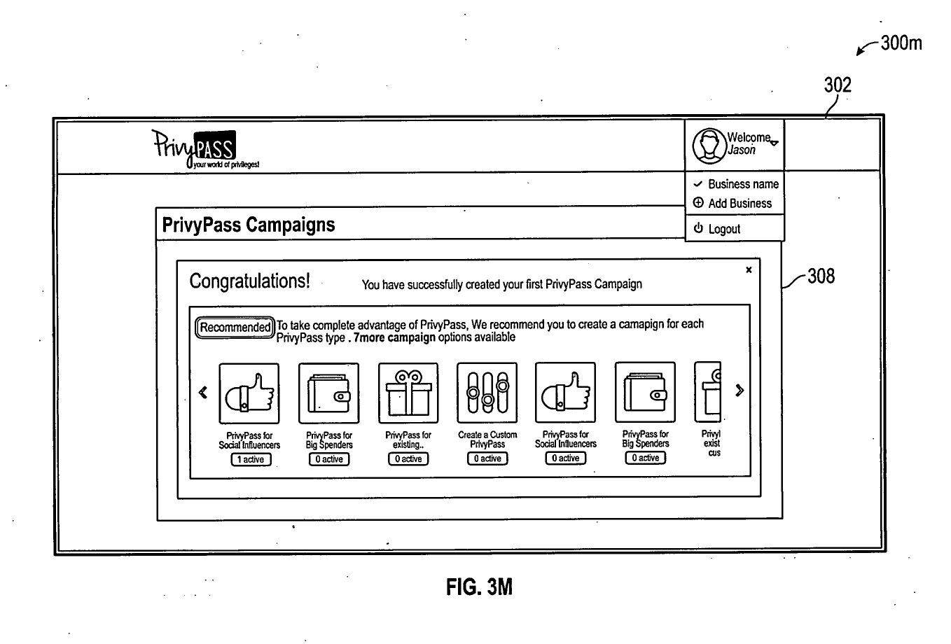

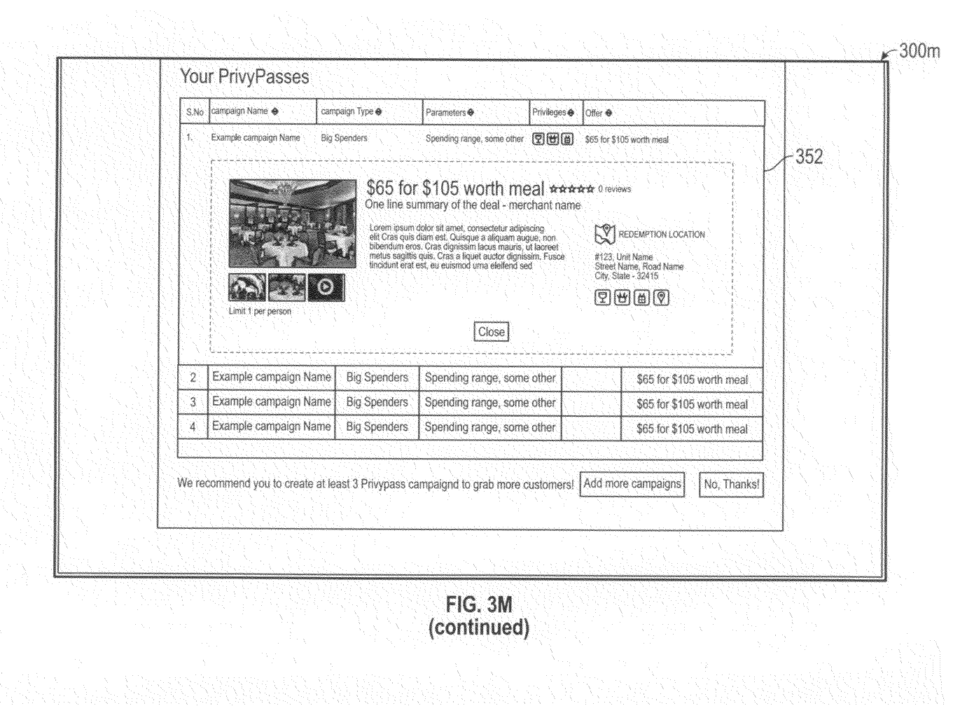

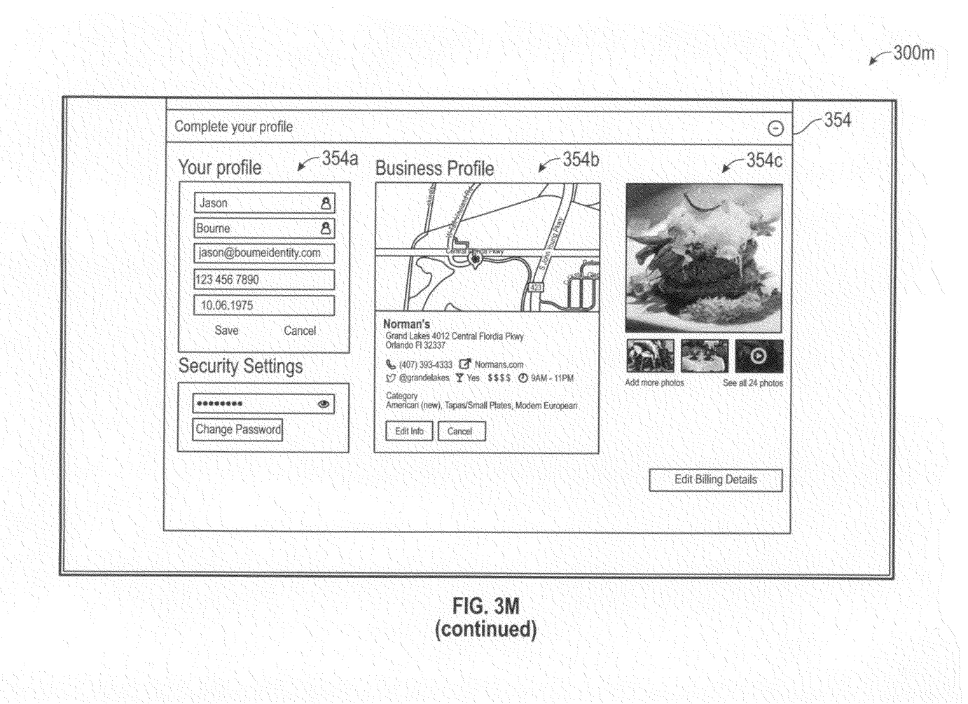

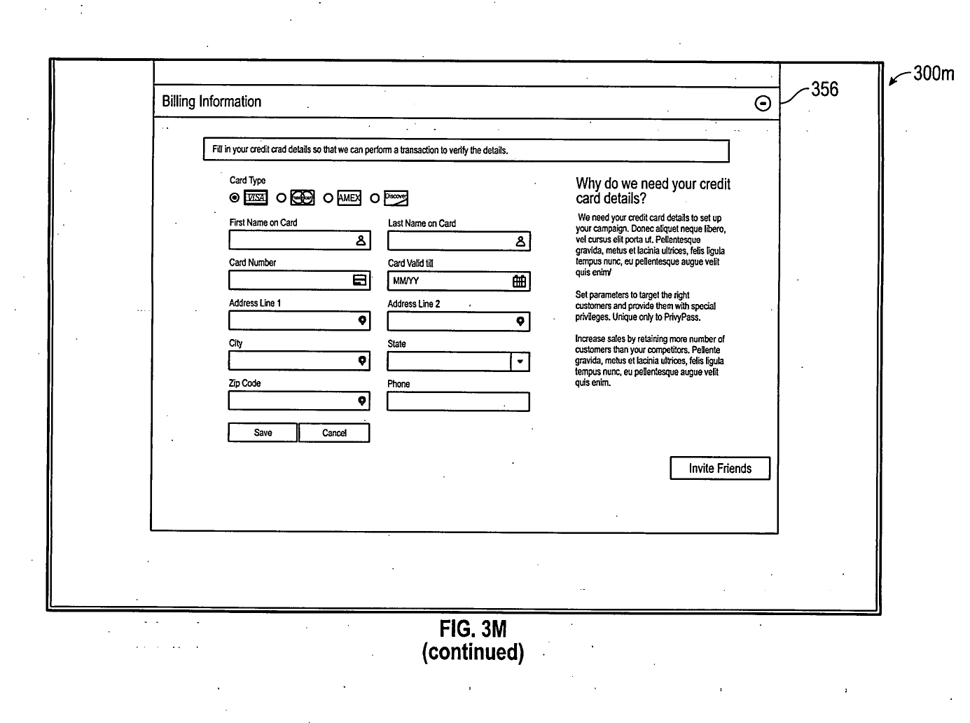

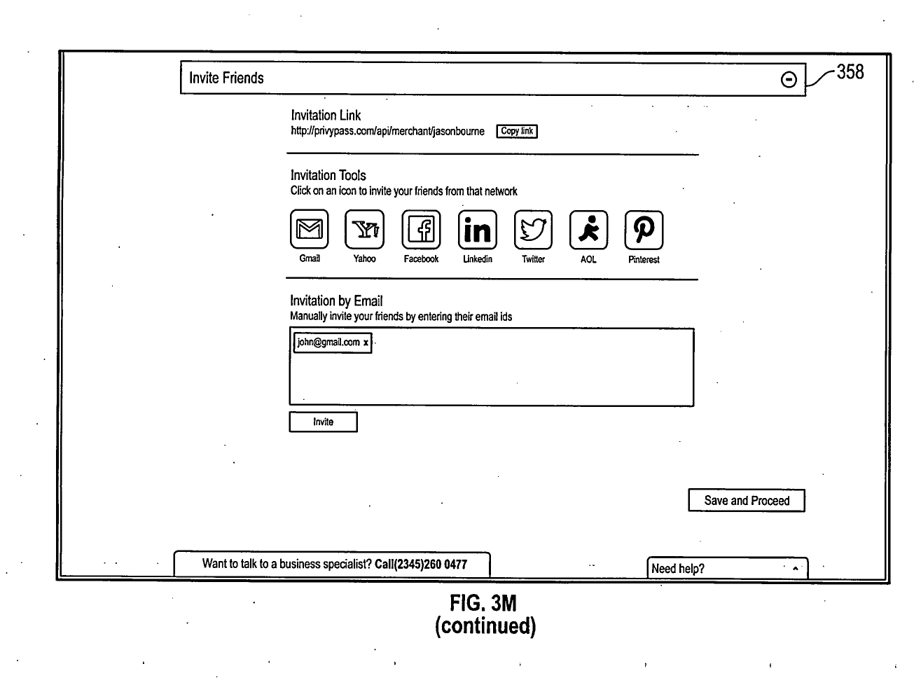

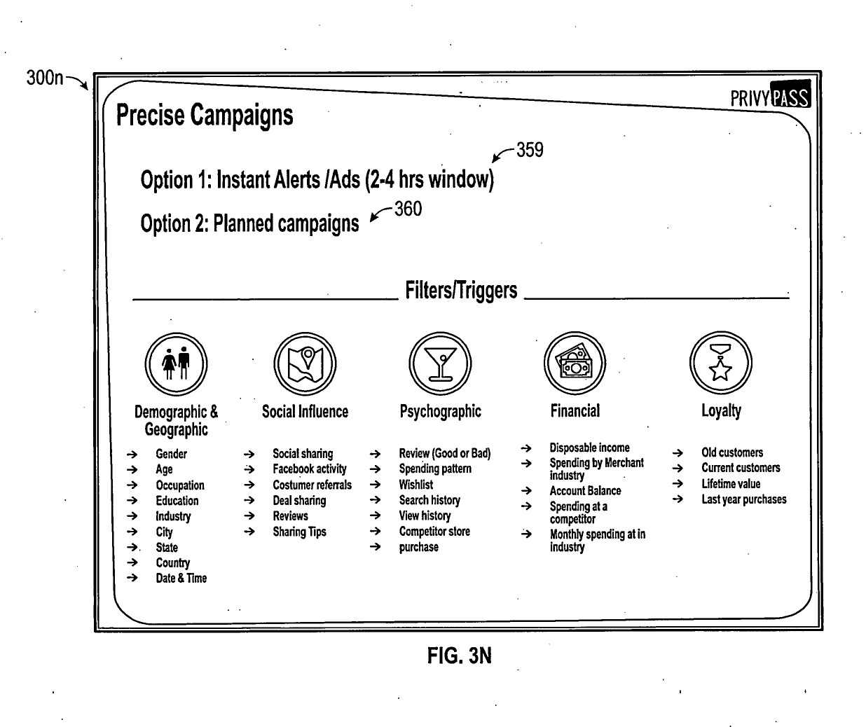

FIG. 3A is a diagram 300a illustrating an exemplary user interface provided by the system for merchants. According to preferred embodiments of the present disclosure, the user interface may include a header 302. In some embodiments, the merchant may have an availability of knowing the functionalities of system before registration. The overview may be described by various tabs which may include but not limited to benefits tab 302a of the system, how it works tab 302b (working process of system), advantages tab 302c, FAQ tab 302d, signup tab 302e and login tab 302f.

As shown in FIG. 3A, the benefits tab 302a may display the details of precise campaign, effective communication and loyalty benefits. The precise campaign details describes that the system allows the merchant to target the respective advertisement campaigns specifically at customers that they would like to visit their store or providing customer benefit services. The effective communication can be achieved by establishing a two way channel between customers and merchants through the system for understanding the customer preferences and further plan promotions to the respective customers. The loyalty benefits may be provided to the different size of business merchants by helping the merchant to setup an affordable and easy to implement loyalty program to retain and reward existing customers and by allowing the customers to redeem the individualized loyalty points associated with the universal loyalty card.

Also as shown in FIG. 3A, the user interface 300a displays a nip and tuck of checkins 306 for both the customers and merchants by logging into their own profiles. The customer check-in may provide a benefit of receiving individualized deals simply by signing up and later by just visiting through the door of merchant. Similarly the merchant check-in may benefit the merchant by providing free access of nano level customer analytics to recognize the preferred customers for their business and help the merchant to plan better campaigns and individualized services.

Further as shown in FIG. 3A, the user interface 300a also displays a brief view of the working process of the system. The process describes that after registration the merchant may be enabled to post an advertisement/deal to the selected preferred customers. The preferred customers may be selected based on the spending habits, manually customized filters and analytically predicted requirements, likes and dislikes and the like. Thus the provided deals would increase the sales of the merchant and further pay the system after getting the customers from it. Also, the customer signup with the system completes the profile and the system analyzes spending parameters of the registered customer by screen the various user accounts such facebook, twitter, payment gateways, and the like, without limiting the scope of the disclosure. Then the proprietary algorithm measures the spending activities of the customer, which would be helpful in scrutinizing the preferred customers by the merchants.

Also further as shown in FIG. 3A, the user interface 300a displays the advantages/comparisons 310 of the conventional system and the current system 106 (FIG. 1A-FIG. 1D). The comparison may be done with the spending activities and also with demographics, social influence, intent to purchase, repeat business, brand attractiveness and distinguishing factor. These features can be compared with conventional systems like groupon, google words, facebook advertisement, other deals website and the like, without limiting the scope of the disclosure. Further the user interface 300a also discloses the various replies provided for the top queries 312 provided by the customers. The queries may include the process of creating an advertisement or campaign in the system, cost to advertise on the system, best practices for writing the advertisement, advertisement targeting options, directing procedure on clicking the advertisement posted by merchant and the like, without limiting the scope of the disclosure.

FIG. 3B is a diagram 300b illustrating an exemplary merchant registration user interface. According to a non limiting preferred embodiment of the present disclosure, the user interface 300b may includes a login tab 314 displayed over the header bar 302, which may be used for logging the registered merchant to access the profile. The registered merchants may be enabled to access the merchant profile pages such as analytics page, reviews provided by the customer, services offered and the like, without limiting the scope of the disclosure.

As shown in FIG. 3B, the user interface 300b may also display a user registration menu 316 to register the new merchants with the system 106. The authentication details may include business name, category of business, business address, first name of the merchant, last name, contact number, email id and the like, without limiting the scope of the disclosure. Thus the provided details are used to register the merchant with the system 106 and also further enable the merchant to login with the provided authentication details for accessing the corresponding page.

Further as shown in FIG. 3B, the user interface 300b may also display additional information 318 which may be related to the loyalty of the system 106 such as the registration with the system is of no cost, the offers provided by the system are relevant and customized specially for the specified merchant and also that each individual registered customer is privileged at their favorite merchant location.

FIG. 3C is a diagram 300c illustrating an exemplary user interface for claiming the business by a registered merchant. According to preferred embodiments of the present disclosure, the user interface 300c may also display a search option 320 used to enter the pre-populated business name 320a along with a pre-populated city and state 320b to claim the business with the system. The provided pre-populated business name 320a with the pre-populated city and state 320b may be analyzed by the predefined data stored in the system and display a list of matching references of the business over a search result 322.

As shown in FIG. 3C, the user interface 300c may also include a navigation option 324 to navigate the registered merchant in claiming their business. The navigation option 324 may be configured to provide the process of claiming the business. For example, if the merchant enters a business name with the specified geographical location of the business, if the business is already listed in the system by the user or by popularity, a simple click “claim it” option 324a provided with the business name listed from the matched results in the search result display 322 is used to claim the business. In some embodiments, if the entered business name is not found in the search results, the merchant may manually add it by using the icon “Add it Now” 324b provided at the bottom of the search result 322 and may select “increase sales” option 324c.

FIG. 3D is a diagram 300d illustrating an exemplary user interface directed to claim the business name of the merchant. According to a non limiting preferred embodiment of the present disclosure, as mentioned in the above FIG. 3c, if the business name is not found in the list of search results, the business may be manually added through a icon “Add it Now”. Thus the process of claiming the new business name is illustrated by the user interface 300d over a business claiming option 326 by providing a required authentication details to claim the business name.

As shown in FIG. 3D, the authentication details required to claim the business name may include but is not limited to pre-populated business name, pre-populated business contact number, pre-populated email, pre-populated website address, pre-populated city, pre-populated state, pre-populated zip code and pre-populated website name and the like. Also along with all the authentication details the merchant may also be allowed to select multiple categories up to a predefined limit which may include but not limited to six and share the information about the business over the specified block. Further, based on the interest of the merchant the system also transmits emails, merchant news, products and services and the like to the specified merchant. Also further along with the authentication details of business name, the individualized credentials such as first name, last name, personal email, mobile number, and password, confirm password and the like are also received from the merchant and confirmed to continue for claiming the business name.

FIG. 3E is a diagram 300e illustrating an exemplary user interface for login of the registered merchant. According to a non limiting preferred embodiment of the present disclosure, the user interface 300d may be presented after the complete registration of the merchant by claiming the business name for logging into the system. The merchant is enabled to login into the system by providing the specified authenticated details such as user name and password in the login tab 314.

FIG. 3F is a diagram 300f illustrating an exemplary user interface for creating a campaign by the merchant. According to preferred embodiment of the present disclosure, the merchant selects a campaign from a predefined list of campaigns 328 provided by the system 106. The list of campaigns 328 may include but is not limited to campaign for social influencer's 328a, campaign for big spenders 328b, campaign for loyal customers 328c, and system customized campaign 328d and the like. Prior to selecting a campaign the complete details of the selected campaign may be provided by the system to the merchant for confirming and proceeding further.

Also as shown in FIG. 3F, the user interface 300f also illustrates the process after selecting a campaign. Thus based on the campaign selected, the target customers may be selected and deals or offers are provided to the corresponding customer.

FIG. 3G is a diagram 300g illustrating an exemplary user interface for selecting target customers. The target customers here may be referred to preferred customers. According to a non limiting preferred embodiment of the present disclosure, the user interface 300g is directed after selecting a campaign as mentioned in FIG. 3F. The user interface 300f is directed to select target customers related to the specified campaign by entering the selected campaign name and a category of business from multiple predefined categories.

As shown in FIG. 3G, the user interface also enables the merchant to set the parameters of spending range for different category of businesses for targeting the customers in the specified range represented by 330. The user interface 300g discloses only five different categories of spending range, which is not limited. Thus based on the categorized customers in the specified range, the maximum numbers of elite customers are targeted to provide deals. The targeted percentage of customers may be displayed over the user interface 300g at prediction block 332.

Also as shown in FIG. 3G, the targeted customers may also be further filtered by providing some other geographical parameters mentioned in the parameters list represented by 334. The geographical location parameters may include in selecting multiple states, multiples cities of the selected states, zip codes of the selected cities, radius from the current location such as 5 miles, 10 miles and the like. Further along with the range of big spenders, the start date and end date is also added to filter the customers in the specified range, demographics are also added, social influencer's or any other option may also be selected in filtering the targeted customers. Also further, the user interface provides few tips 336 related to the system 106.

FIG. 3H is a diagram 300h illustrating an exemplary user interface of turning customers to loyalist customers. The loyal customers here may also be referred as preferred customers. According to a non limiting preferred embodiment of the present disclosure, the loyal customers are formed by providing best services by assigning a dedicated service manager to the privileged customer. The merchant is enabled to select a dedicated service manager to the each individual privileged customer by providing a specified manager first name, last name, contact number and email address represented by 338. In some embodiments, based on the interest of the merchant multiple numbers of the dedicated service managers may also be assigned to the single preferred customer.

As shown in FIG. 3H, the details of the selected dedicated service manager are displayed at 342 as manager name, email id of manager and contact number of the manager along with the respective executive name and number. Also as shown in FIG. 3H, the customer service 340 may also be displayed on the user interface 300g to indicate service offered to the customer.

FIG. 3I is a diagram 300i illustrating an exemplary user interface for creating a deal to the preferred customer. According to preferred embodiments of the present disclosure, the user interface 300i may be used to create deal for the preferred customer. The merchant may be enabled to create a deal for the specified customer at 344 by writing the service and deal details with deal title and summary of the deal. For example, the deal title can be written as “$65 to $105 worth meal” and the summary can be “special thanks giving dinner”. Also along with the deal title entered by the merchant, the corresponding image offered is also displayed on the user interface.

FIG. 3J is a diagram 300j illustrating another exemplary user interface for creating a deal to the preferred customer. According to embodiments of the present disclosure, the merchant may be enabled to create deal for the privileged customer as shown in FIG. 3I and further enabled to upload photos and videos represented by 344 corresponding to the created deal.

FIG. 3K is a diagram 300k illustrating another exemplary user interface for creating a deal to the preferred customer. According to preferred embodiments of the present disclosure, the merchant may also further provide price and discount details of the created deal represented by 348. For example the initial price of the deal can be $65 and in discount the same can be offered to the preferred customer for only $30.

FIG. 3L is a diagram 300l illustrating another exemplary user interface for creating a deal to the preferred customer. According to preferred embodiments of the present disclosure, the merchant may also provide the geographical location details and redeem options represented by 350 for the deal created to the preferred customer. For example the location details can be flat number, street name, road name, city name, country, pin code and the redeem options can be provided by entering the coupon number. The redeem options can be selected by the merchant for enabling the customer to pay for the deal. The redemption may also be availed using the universal loyalty card. In some embodiments the redeem option selected by the merchant by entering the coupon code. In some embodiments, the redeem option selected by the merchant, enables the customer to pay the complete amount for the deal and the difference amount after deducting the commission from the paid amount is returned to system 106. In some embodiments, the redeem options selected by the merchant may enables the customer to pay the half amount to the merchant and the remaining amount directly to the system 106.

FIG. 3M is a diagram 300m illustrating an exemplary user interface displaying merchant dashboard. According to preferred embodiments of the present disclosure, the dashboard of the merchant may display a header bar 302 with the name of the merchant and information represented by 308 that the merchant has successfully created merchant campaign.

As shown in FIG. 3M, the user interface 300m may also display a campaign list 352 comprising at least three campaigns. The campaign list 352 is displayed along with the campaign name, campaign type, parameters, privileges and offer. For example the campaign list 352 may include campaign name as the system name, campaign type as big spenders, parameters as spending range, type of privileges offered to the customer can be selected, and offer may be referred as providing $65 for $105 worth meal. Similarly the three different campaigns may also be displayed in the campaign list 352.

Also as shown in FIG. 3M, the user interface 300m may enable the merchant to complete profile represented by 354a by filing the individualized credentials and security settings. The merchant also enabled to complete business profile by providing map location 354b, address and upload the images 354c related to the offers provided to the privileged customers. The user interface 300m also includes a billing information 356 used to enable the merchant to fill the payment details to set up the campaign. The payment details include selecting the type of card such as visa, master card, amex and discover and the like and enter the respective authenticated details of the card such as first name on card, last name on card, card number, card valid till, address, city, state, zip code, phone and the like.

Further as shown in FIG. 3M, after setting up a campaign, the merchant may be enabled to invite friends represented by 358 by sending the link to the friends or by using the invitation tools such as yahoo, gmail, facebook, linkedin, twitter, AOL, pinterest and the like or by manually inviting the friends by entering the specified mail id of the each individual friend.

FIG. 3N is a diagram 300N depicting en exemplary user interface of a merchant for creating precise campaigns. As shown in FIG. 3N the merchant may be provided with at least two options 359 and 360. In some embodiments, Option 359 may be used by the merchant′ to crate instant alerts/advertisements and post to the customer and Option 360 enables the merchants to create planned campaigns. The merchant may use one or filters/triggers to select the merchant. The merchant may select or target the customers based on demographic and geographic, social influence, psychographic, financial, loyalties and the like as a shown in 300N, without limiting the scope of the disclosure. Demographic and geographic filters/triggers may include but is not limited to gender, age, occupation, education, industry, city, state, country, date & time. Social influence filters/triggers may include but is not limited to social sharing, facebook activity, customer referrals, deal sharing, reviews, sharing tips. Psychographic filters/triggers may include but is not limited to review (good or bad), spending pattern, wishlist, search history, view history, competitor store, purchase. Financial filters/triggers may include but is not limited to disposable income, spending by merchant industry, account balance, spending at a competitor, monthly spending at industry. Loyalties/triggers may include but is not limited to old customers, current customers, lifetime value, last year purchases.

FIG. 3O is a diagram 300O depicting an user interface of merchant viewing customer profile. The merchant may view consumer analytics 361 which may include but is not limited to transactions, reviews, checkins, grade, loyalty rank, spendability, facebook and twitter activity, reviews and activity levels, statistics and the like without limiting the scope of the disclosure.

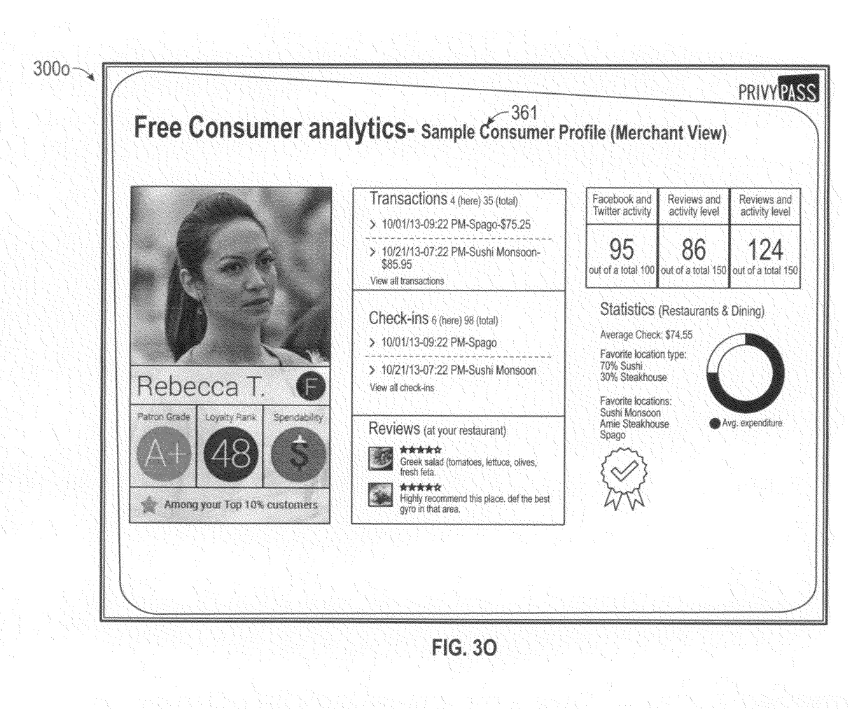

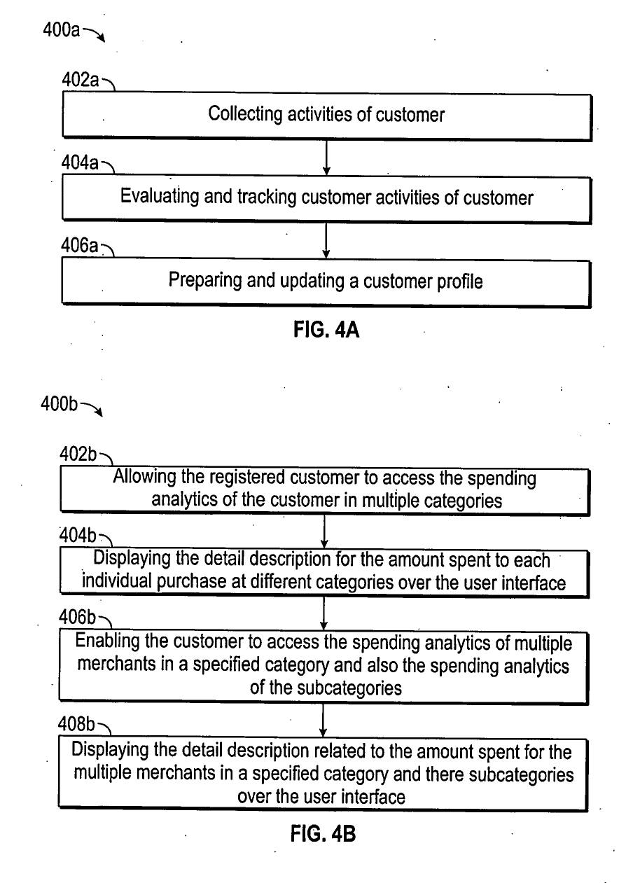

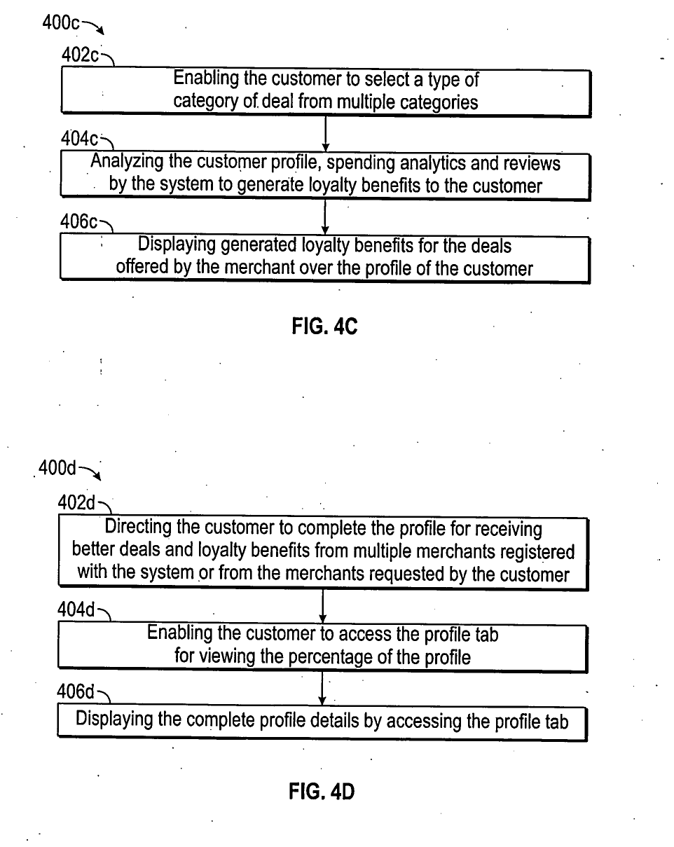

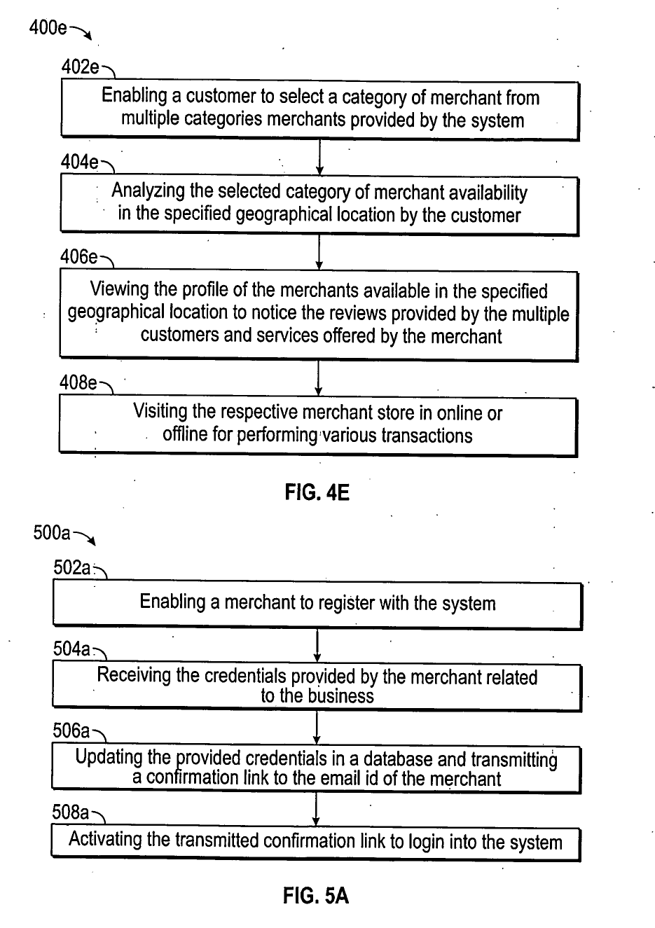

FIG. 4A is a flow diagram 400a depicting an exemplary method of tracking and evaluating activities of customer. The method starts at step 402, wherein the activities of the customer are collected by the system 106 (FIG. 1A-FIG. 1D). The activities of the customer may be collected from the financial intermediaries with whom the customer holds the account and/or credit card and/or debit card and form social networking domains and based on psychographic behaviour of the customer. The activities of the customer may also be instantaneously collected from the transaction alerting service collecting gateway and social media gateway. At step 404, the collected activities are evaluated for identifying types of merchants with whom the customer has performed a spending activity and analyzing the spending behavior of the customer, evaluating social influence of the customer on social networking domains and the like, without limiting the scope of the disclosure. At step 406, a customer profile is prepared in response to evaluating the spending activities for enabling the merchants to view the customer profile. The merchants identify the customer as a preferred customer by viewing the customer profile and provide privileged services.

FIG. 4B is a flow diagram 400B illustrating an exemplary method of viewing spending activities by the customer. At step 402b, the customer is allowed to access the spending activities in multiple categories such as clothing/shoes, restaurants/dining, travel, general merchandise, insurance and the like, without limiting the scope of the disclosure. The detailed description for the amount spent on each individual purchase at different categories is displayed over the user interface at 404b. Next at step 406b, the customer is also enabled to access the spending activities with multiple merchants in a specified category and also the analytics corresponding to the subcategories of the main category. For example, if clothing/shoes is the main category, the subcategories may include women clothing, sports bars, pubs, American (New), fashion, leather goods, mens clothing and the like, without limiting the scope of the disclosure. Thus the spending corresponding to the merchants in the clothing/shoes category and there subcategories are provided to customer. Further at step 408b, the detailed description related to the amount spent for the multiple merchants in a specified category and there subcategories may be displayed over the user interface.

FIG. 4C is a flow diagram 400c illustrating an exemplary method of displaying loyalty benefits provided by the merchants. The method starts at step 404c by enabling the customer to select a category of deal from multiple categories. Next at step 404c the system 106 (FIG. 1A-FIG. 1D) analyzes the customer profile, activities, loyalty benefits associated with universal card of the customer and reviews to generate reward benefits to the customer. The generated reward benefits for the rewards offered by the merchant may be displayed over the user interface of the customer loyalty tab at step 406c. The displayed reward benefits include the reviews provided to the merchant, points earned by the customer, balance reward points, rewards made by the customer with specified merchant and the like. The rewards offered to the customers may be targeted rewards or sponsored rewards. The rewards offered may be redeemed with a specific merchant who provided the reward points, with competitor merchants, with multiple merchants, and the like.

FIG. 4D is a flow diagram 400d illustrating an exemplary method updating the customer profile for receiving loyalty benefits. According to preferred embodiments of the present disclosure, the method starts at step 402d by directing the registered customer to complete the profile for receiving better deals and loyalty benefits from multiple merchants registered in general and/or from the merchants requested by the customer. The customer may update the profile by providing the spending activity details, providing reviews to the merchants, by inviting friends and the like. In response to updating the profile, the customer may be provided with additional loyalty benefits by the system and/or by the merchants. The gained loyalty benefits may be redeemed with the universal loyalty card or directly without using the universal loyalty card. Next at step 404d the customer may be enabled to access the profile tab for viewing the percentage of the profile completeness. Further at step 406d the accessed profile tab may also display the complete profile details such as name, percentage of profile completion, deals used, reviews generated, comments provided, friends added, and member since, along with the live updates for the customer activities, without limiting the scope of the disclosure.

FIG. 4E is a flow diagram 400e illustrating an exemplary method of filtering merchants by the customers. According to a preferred embodiment of the present disclosure, the method of filtering merchants starts at step 402e by enabling a customer to select a category of merchant from multiple categories merchants provided by the system. Next at step 404e, the customer analyzes the selected category of merchant availability in the specified geographical location. Further at step 406e, the available merchants profile may be viewed by the customer to notice the privileged services offered by the merchant, loyalty benefits provided by the merchant and the reviews provided by the multiple customers. Thus the selected merchant store may be visited by the customer through on-line or off-line for performing transactions at step 408e.

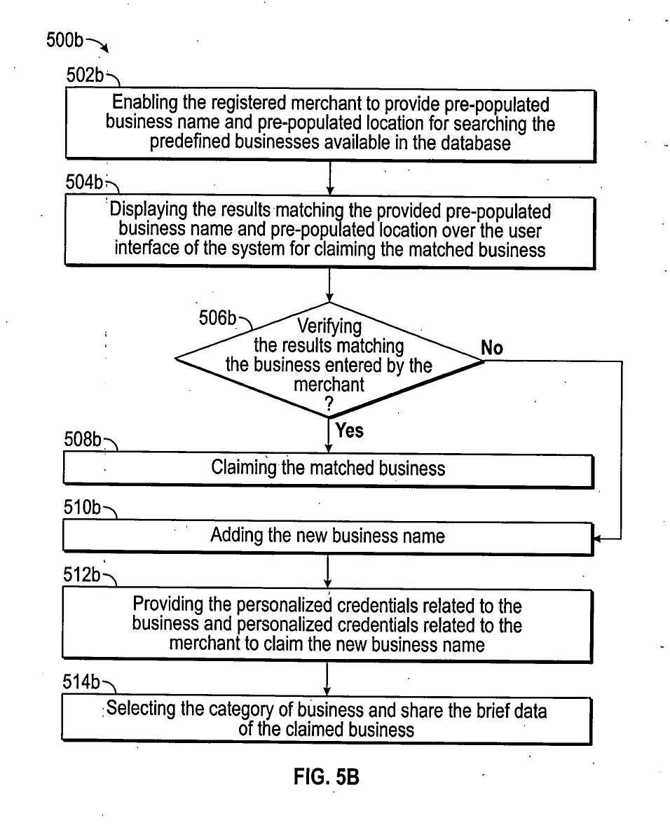

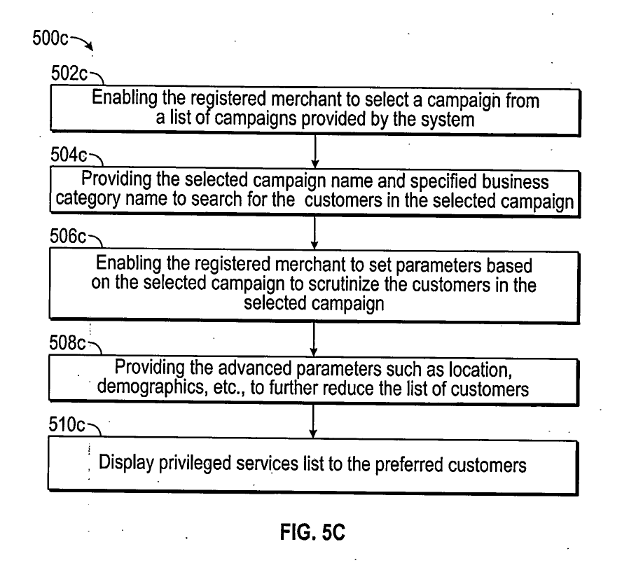

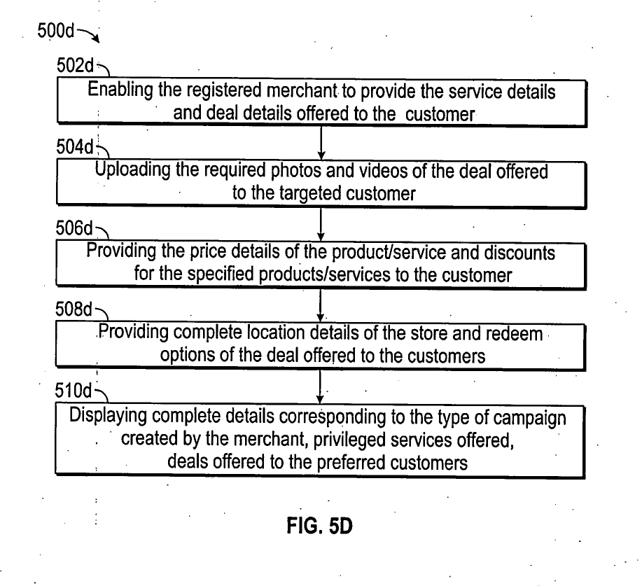

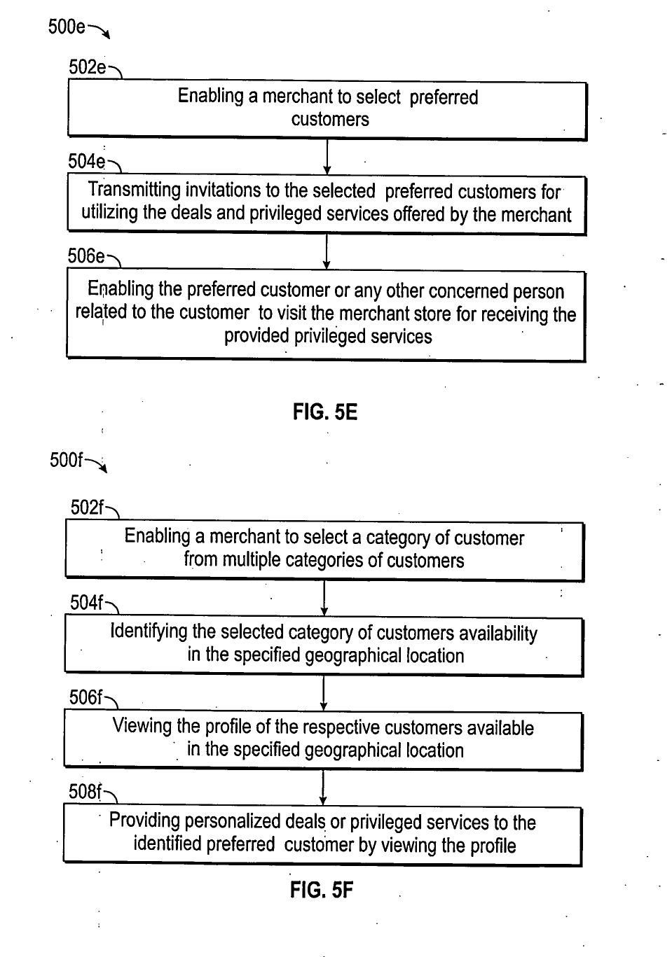

FIG. 5A is a flow diagram 500a illustrating an exemplary registration process of merchant. According to preferred embodiments of the present disclosure, the method of registration starts at step 502a by enabling a merchant to register with the system. Next at step 504a the merchant is enabled to provide the credentials related to the business such as business name, business category, business address, first name of merchant, last name of merchant, contact number, email id and the like, without limiting the scope of the disclosure.

As shown in the FIG. 5A the provided credentials of merchant are updated in the merchant database at step 506a and the confirmation link is sent to the email id of the merchant. Further at step 508a the confirmation link received by the merchant is activated to login into the system.

FIG. 5B is a flow diagram 500b illustrating an exemplary method of claiming merchant's business. The method of claiming the business starts at step 502b by enabling the registered merchant to provide pre-populated business name and pre-populated location for searching the predefined businesses available in the database. Next at step 504b the results matching the provided pre-populated business name and pre-populated location may be displayed for claiming the matched business.

Further as shown in FIG. 5B, the registered merchant verifies whether the provided results match the business or not at step 506b. If the displayed results match the merchants business at step 506b the method continues with step 508b in claiming the matched business. If the displayed results do not match the merchant business at step 506b, the method continues with step 510b in adding the new business, the merchant interested to claim. Thus as shown in FIG. 5B, in order to claim the new business name, the individualized credentials related to business and the individualized credentials of the merchant provided in the specified categories at step 512b. The individualized credentials related to business may include but is not limited to pre-populated business name, pre-populated business contact number, pre-populated email, pre-populated business address, pre-populated location, pre-populated zip code, pre-populated website name and the like and the individualized credentials corresponding to the merchant may include first name, last name, personal email, mobile number, password, confirm password and the like. Also further, along with the individualized credentials of business, the merchant may also select a category of business at step 514b and share the data related to the business briefly.

FIG. 5C is a flow diagram 500c illustrating an exemplary method of creating a campaign by the merchant. According to preferred embodiment of the present disclosure, the method of creating a campaign starts at step 502c by enabling the registered merchant to select a campaign from a list of campaigns provided by the system. Next at step 504c the selected campaign name and specified business category name may be provided to search for the customers in the respective campaign.

As shown in FIG. 5C, at step 506c the merchant is enabled to set parameters based on the selected campaign to scrutinize the customers in the selected campaign. The customers are scrutinized based on the parameters like spending activities, number individualized individualized loyalty points associated with the universal loyalty card of the customer, amount spent with the respective merchant, number of visits to the merchant and the like. For example if the selected campaign is big spender, the parameters can be the spending range of the customers. Next at step 508c, the merchant also provides advanced parameters including geographical location such as states, cities, zip codes, radius from location and the like and demographics, social influencer's and similar other options to further the reduce the customers in the specified geographical location. Further at step 510c, privileged services list is displayed to the scrutinized customers in the specified campaign. The scrutinized customers may be preferred customers to the merchant. The merchant may add deals to the created campaign.

FIG. 5D is a flow diagram 500d illustrating a method of creating a deal to the customers by the merchant. According to preferred embodiments of the present disclosure, the method of creating a deal starts at step 502d by enabling the registered merchant to provide the service details and deal details to the preferred customer for the corresponding campaign. Next at step 504d, the merchant may also upload the required photos and videos corresponding to the deal and also provide the price details of the respective product/service and discounts for the specified products/services at step 506d for the corresponding campaign. Further as shown in FIG. 5D, the merchant also provides the complete location details and individualized loyalty points redeem options corresponding to the deal offered to the customers at step 508d for providing an easy move to the customers. Next at step 510d the complete details corresponding to the type of campaign created by the merchant, privileged services offered, deals offered to the preferred customers for receiving the provided privileged services.

FIG. 5E is a flow diagram 500e illustrating a method of transmitting invitations to privileged customers by the merchants. According to a preferred embodiment of the present disclosure, the method of transmitting invitations to the privileged customers starts at step 502e by enabling the merchant to select preferred customers from the multiple customers. Next at step 504e, the selected preferred customer receives an invitation transmitted by the merchant for utilizing the special deals and privileged services along with the loyalty benefits and redemption of loyalty benefits. Further at step 506e, the received invitation is used by the customer or any other concerned person related to the customer for receiving the privileged services and/or redeeming the individualized loyalty points using the universal loyalty card.

FIG. 5F is a flow diagram 500f illustrating a method of filtering preferred customers by the merchants. According to preferred embodiments of the present disclosure, the method of filtering preferred customer starts at step 502f by enabling the merchant to select a category of customers from multiple categories of customers. Next at step 504f, the merchant identifies the selected category of preferred customer's availability in the current geographical location. Further at 506f, the identified preferred customers profile is viewed to provide individualized deals and privileged services to the identified preferred customers at step 508f.

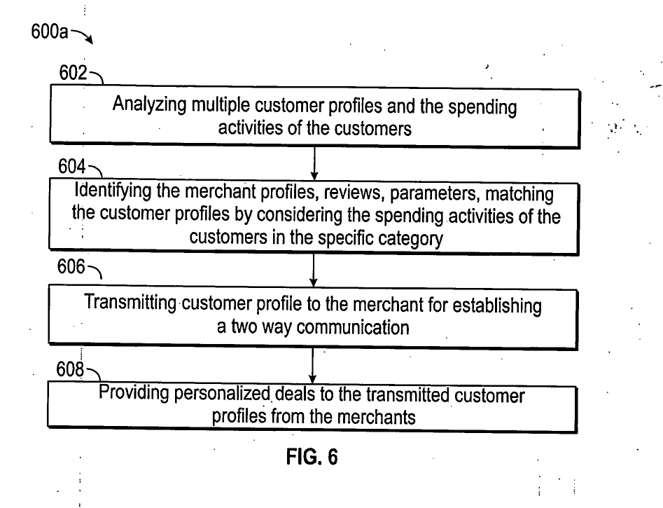

FIG. 6 is a flow diagram 600 illustrating an exemplary method of analyzing customer profiles for providing preferred customer list to the merchants. According to a non limiting preferred embodiment of the present disclosure, the method starts at 602 by analyzing multiple customer profiles registered with the system and the activities of the corresponding customers to transmit the list of eligible customers to the each individual merchant in different categories.

As shown in FIG. 6, at step 604 the system identifies the merchant profiles, reviews, parameters, and the like matching the customer profiles by considering the activities of the eligible customers in the specific category. Next at step 606 the system after finalizing the merchant profiles, reviews, parameters, and the corresponding customer profile is transmitted to the merchant for establishing a two way communication. Further at step 608 the transmitted eligible customer profiles may be considered as preferred customers and may be offered with the individualized deals and loyalty benefits by the merchants.

1. A method for creating and updating a customer profile, the method comprising:
collecting a plurality of individualized details of customer; and activities of the customer;
evaluating the plurality of individualized details of customer and activities of the customer; and
creating a customer profile in response to the plurality of individualized details of customer and activities of the customer for enabling the plurality of merchants to view the customer profile, whereby the plurality of merchants identify the customer as a preferred customer by viewing the customer profile and provide privileged services.

2. The method of claim 1, wherein the individualized details of the customer comprising demographic and geographic details of the customer.

3. The method of claim 1 comprising a step of updating the customer profile in response to the plurality of spending activities of the customer with the plurality of merchants.

4. The method of claim 1 comprising a step of collecting the plurality of spending activities of the customer from a plurality of merchant terminals.

5. The method of claim 1 comprising a step of updating the customer profile in response to the plurality of online and offline social activities of the customer.

6. The method of claim 1 comprising a step of updating the customer profile based on the psychographic behaviour of the customer.

7. The method of claim 1 comprising a step of updating the customer profile based on a loyalty points of the customer.

8. The method of claim 1 comprising a step of updating the customer profile based on the system activities.

9. The method of claim 1 comprising a step of updating the customer profile based on customer-to-merchant relational data.

10. The method of claim 1 comprising a step of updating the customer profile based on merchant-to-customer relational data.

11. The method of claim 1 comprising a step of updating customer profile based on income sources.

12. The method of claim 1 comprising a step of filtering a plurality of customer profiles by the plurality of merchants for indentifying a plurality of preferred customers.

13. The method of claim 1 comprising a step of providing loyalty points by the plurality of merchants.

14. A method for creating and updating a customer profile, the method comprising:
collecting a plurality of individualized details of customer; and activities of the customer;
evaluating the plurality of individualized details of customer and activities of the customer; and
creating a customer profile in response to the plurality of individualized details of customer and activities of the customer for enabling the plurality of merchants to view the customer profile, whereby customer profile customized for a specific merchant of a specific category.

15. The method of claim 11 comprising a step of dynamically preparing a list of preferred customers list in response to correlating the customized customer profile and the services offered by a merchant of specific category.

16. The method of claim 11 comprising a step of enabling the plurality of merchants to conduct a plurality of campaigns for providing loyalty points to the customer.

17. The method of claim 15, wherein the step of providing loyalty points to the customer comprising a step of evaluating and tracking activities of the customer in the plurality of campaigns.

18. A system comprising:
a system for creating and updating customer profile;
a financial intermediary gateway configured for collecting a plurality of spending activities associated with a plurality of financial transactions performed by a customer with a plurality of merchants, whereby the plurality of financial transactions collected from one or more financial intermediaries;
a financial transaction alerting gateway configured to instantaneously collect a plurality of spending activities associated with a plurality of financial transactions performed by a customer with a plurality of merchants, whereby the plurality of financial transactions collected from one or more transaction alert service providers; and
a social media gateway configured to collect one or more social activities performed by one or more customers on one or more social networking domains.
